(19) United States
(12) Patent Application Publication
(10) Pub. No.: US 2018/0359976 A1
(43) Pub. Date: Dec. 20, 2018

(54) SYSTEMS AND METHODS FOR PROVIDING AN ASSEMBLY LINE GROW POD

(71) Applicant: Grow Solutions Tech LLC, Lehi, UT (US)

(72) Inventors: Gary Bret Millar, Highland, UT (US); Mark Gerald Stott, Eagle Mountain, UT (US); Todd Garrett Tueller, American Fork, UT (US); Michael Stephen Hurst, Farmington, UT (US); Alan Ray Bentley, Alpine, UT (US); Taylor John Woodbury, Provo, UT (US); Kevin Hurst, Pleasant Grove, UT (US)

(21) Appl. No.: 15/996,100

(22) Filed: Jun. 1, 2018

Related U.S. Application Data
(60) Provisional application No. 62/519,304, filed on Jun. 14, 2017.

(51) Int. Cl. A01G 31/04; A01G 9/08; A01G 9/24; A01G 25/16

(52) U.S. Cl. CPC A01G 31/042; A01G 25/16; A01G 9/24; A01G 9/085

(57) ABSTRACT

Systems and methods for providing an assembly line grow pod are provided. One embodiment of a grow pod includes an exterior enclosure that defines an environmentally enclosed volume, a track that that is shaped into a plurality of helical structures defining a path, and a cart that receives a plant and traverses the track. Some embodiments include a sensor for determining output of the plant, a plurality of environmental affecters that alter an environment of the environmentally enclosed volume to alter the output of the plant, and a pod computing device that stores a grow recipe that, when executed by a processor of the pod computing device, actuates at least one of the plurality of environmental affecters. In some embodiments, the grow recipe alters a planned actuation of the at least one of the plurality of environmental affecters in response to data from the sensor indicating a current output of the plant.

### CROSS REFERENCE

This application claims the benefit of U.S. Provisional Application Ser. No. 62/519,304, filed Jun. 14, 2017, which is hereby incorporated by reference in its entirety.

### TECHNICAL FIELD

Embodiments described herein generally relate to systems and methods for providing an assembly line grow pod and, more specifically, to an assembly line grow pod that wraps around a plurality of vertical axes.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, while the United States currently has suitable farmland to adequately provide food for the U.S. population, other countries and future populations may not have enough farmland to provide the appropriate amount of food.

### SUMMARY

Systems and methods for providing an assembly line grow pod are provided. One embodiment of a grow pod includes an exterior enclosure that defines an environmentally enclosed volume, a track that is shaped into a plurality of helical structures defining a path, and a cart that receives a plant and traverses the track. Some embodiments include a sensor for determining output of the plant, a plurality of environmental affecters that alter an environment of the environmentally enclosed volume to alter the output of the plant, and a pod computing device that stores a grow recipe that, when executed by a processor of the pod computing device, actuates at least one of the plurality of environmental affecters. In some embodiments, the grow recipe alters a planned actuation of the at least one of the plurality of environmental affecters in response to data from the sensor indicating a current output of the plant.

One embodiment of a system includes an assembly line grow pod that includes an exterior enclosure that defines an environmentally enclosed volume, a track that is shaped into a plurality of helical structures defining a path, and a cart that includes a tray that receives a plurality of seeds in the tray and traverses the track. In some embodiments, the grow pod includes a sensor for determining output of the plurality of seeds, an environmental affecter that alters an environment of the environmentally enclosed volume to alter the output of the plurality of seeds, and a pod computing device that stores a grow recipe that, when executed by a processor of the pod computing device, actuates the environmental affecter. In some embodiments, the grow recipe alters a planned actuation of the environmental affecter in response to data from the sensor indicating a current output of the plurality of seeds.

In some embodiments, an assembly line grow pod includes an exterior enclosure that defines an environmentally enclosed volume, a track that is shaped into a plurality of helical structures defining a path, and a plurality of carts that each receives a respective seed for growing into a plant, wherein each of the plurality of carts traverses the track. Some embodiments include a sensor for determining output of the plant, an environmental affecter that alters an environment of the environmentally enclosed volume to alter the output of the plant, and a pod computing device that stores a grow recipe that, when executed by a processor of the pod computing device, actuates the environmental affecter. In some embodiments, the grow recipe alters a planned actuation of the environmental affecter in response to data from the sensor indicating a current output of the plant.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an exterior enclosure for an assembly line grow pod, according to embodiments described herein;

FIG. 2 depicts an assembly line grow pod, according to embodiments described herein;

FIG. 3A depicts a plurality of components for an assembly line grow pod, according to embodiments described herein;

FIG. 3B depicts a seeder component for an assembly line grow pod, according to embodiments described herein;

FIG. 3C depicts a harvester component for an assembly line grow pod, according to embodiments described herein;

FIG. 3D depicts a sanitizer component of an assembly line grow pod, according to embodiments described herein;

FIGS. 4A, 4B depict a cart for receiving plants and seeds in an assembly line grow pod, according to embodiments described herein;

FIGS. 5A, 5B depict various configurations of a bed seed holder, according to embodiments described herein;

FIG. 6 depicts a plurality of carts on a track of an assembly line grow pod, according to embodiments described herein;

FIG. 7 depicts an overhead view of a bypass configuration for a track of an assembly line grow pod, according to embodiments described herein;

FIG. 8 depicts a sustenance component for providing water and/or nutrients to a plant in an assembly line grow pod, according to embodiments described herein;

FIG. 9 depicts a communication network for operating an assembly line grow pod, according to embodiments described herein;

FIG. 10 depicts a flowchart for harvesting a crop from an assembly line grow pod, according to embodiments described herein;

FIG. 11 depicts a flowchart for determining whether plants in an assembly line grow pod have received an excessive amount of water, according to embodiments described herein;

FIG. 12 depicts a flowchart for determining whether a plant can be harvested in an assembly line grow pod, according to embodiments described herein;

FIG. 13 depicts a flowchart for determining whether a cart in an assembly line grow pod has been sanitized, according to embodiments described herein;

FIG. 14 depicts a flowchart for determining whether a cart in an assembly line grow pod is malfunctioning, according to embodiments described herein;

FIG. 15 depicts a flowchart for determining whether a plant has been damaged in an assembly line grow pod, according to embodiments described herein; and

FIG. 16 depicts a computing device for an assembly line grow pod, according to embodiments described herein.

### DETAILED DESCRIPTION

Embodiments disclosed herein include systems and methods for providing an assembly line grow pod. Some embodiments are configured with an assembly line of plants that follow a track that wraps around a first axis in a vertically upward direction and wraps around a second axis in vertically downward direction. These embodiments may utilize light emitting diode (LED) components for simulating a plurality of different light wavelengths of photons for the plants to grow. Embodiments may also be configured to individually seed one or more sections of a tray on a cart, as well as provide a predetermined amount of water and/or a predetermined amount of nutrients to individual cells that hold those seeds.

As such, embodiments described herein may be configured to determine an error that has occurred with the assembly line grow pod. Based on the type of error and/or other characteristics, the assembly line grow pod may attempt to salvage plants on the cart while addressing the error. The systems and methods for providing an assembly line grow pod incorporating the same will be described in more detail, below.

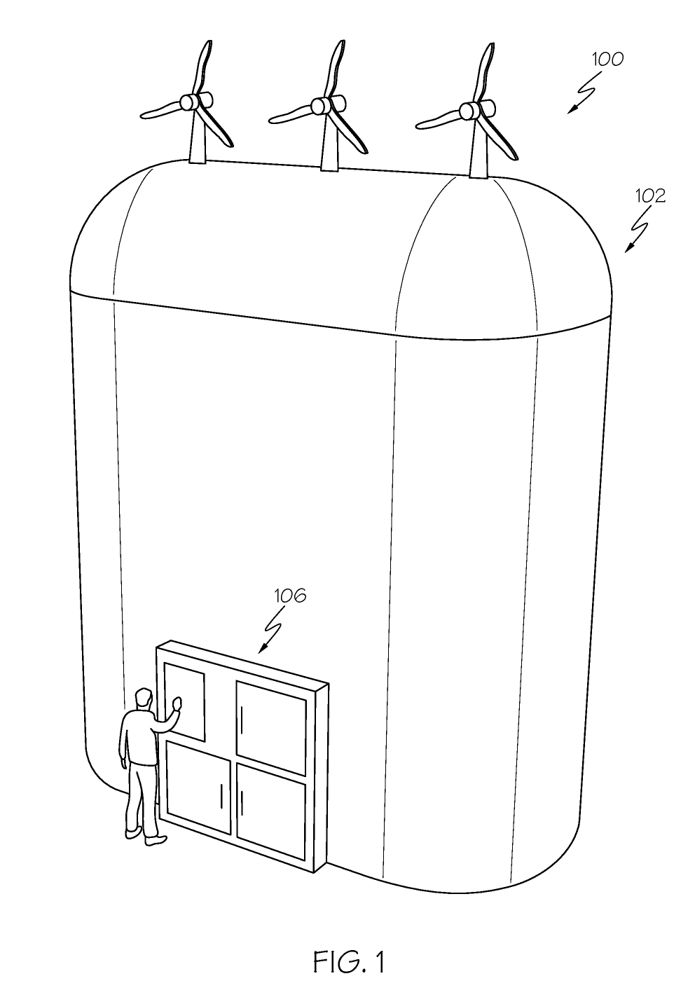

Referring now to the drawings, FIG. 1 depicts an exterior enclosure 100 for an assembly line grow pod 102, according to embodiments described herein. As illustrated, the assembly line grow pod 102 may be a fully enclosed structure that is enclosed by the exterior enclosure 100 to provide an environmentally enclosed volume. Depending on the embodiment, the exterior enclosure 100 may provide a pressurized environment to prevent (or at least reduce) insects, mold, and/or other organisms and contaminants from entering the exterior enclosure 100. Similarly, some embodiments may be configured for simulating altitude inside the exterior enclosure 100. As such, the exterior enclosure 100 may include one or two layers of independent pressurized environments.

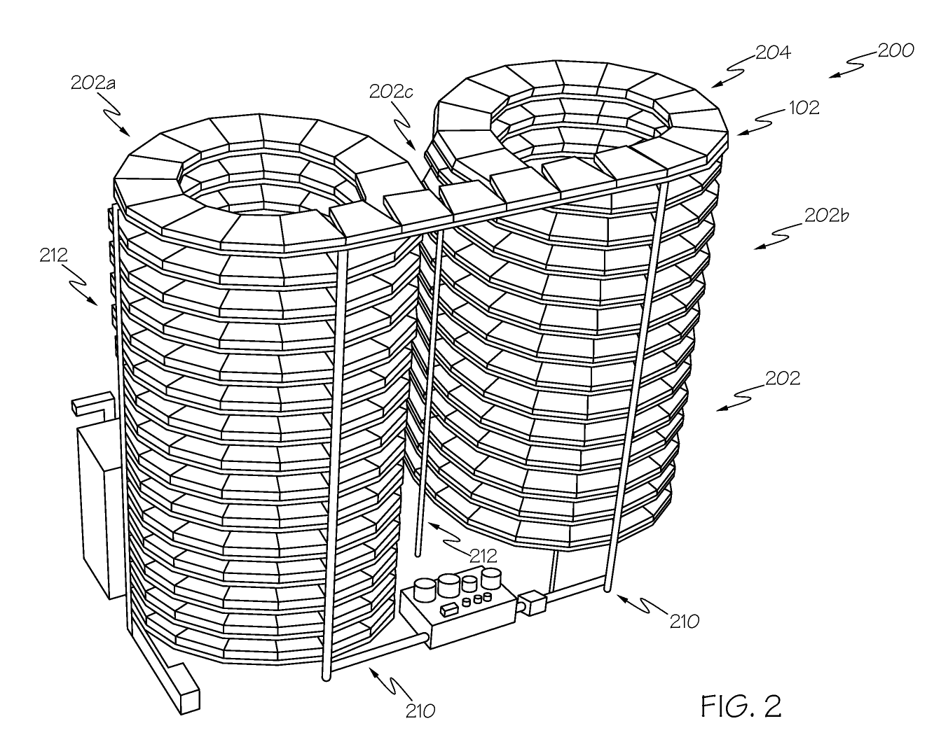

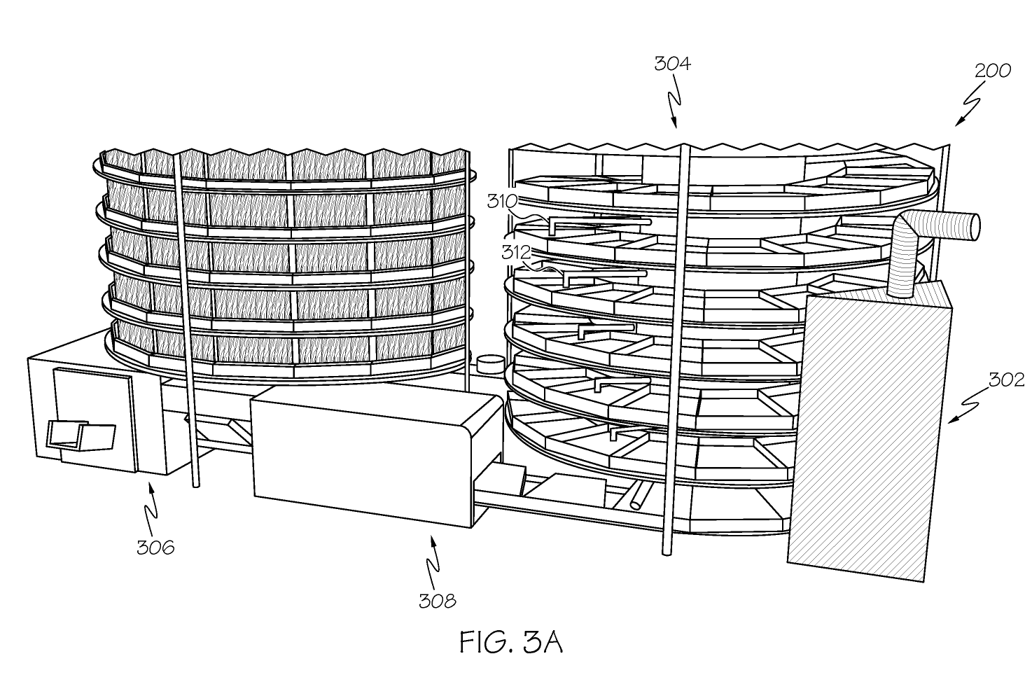

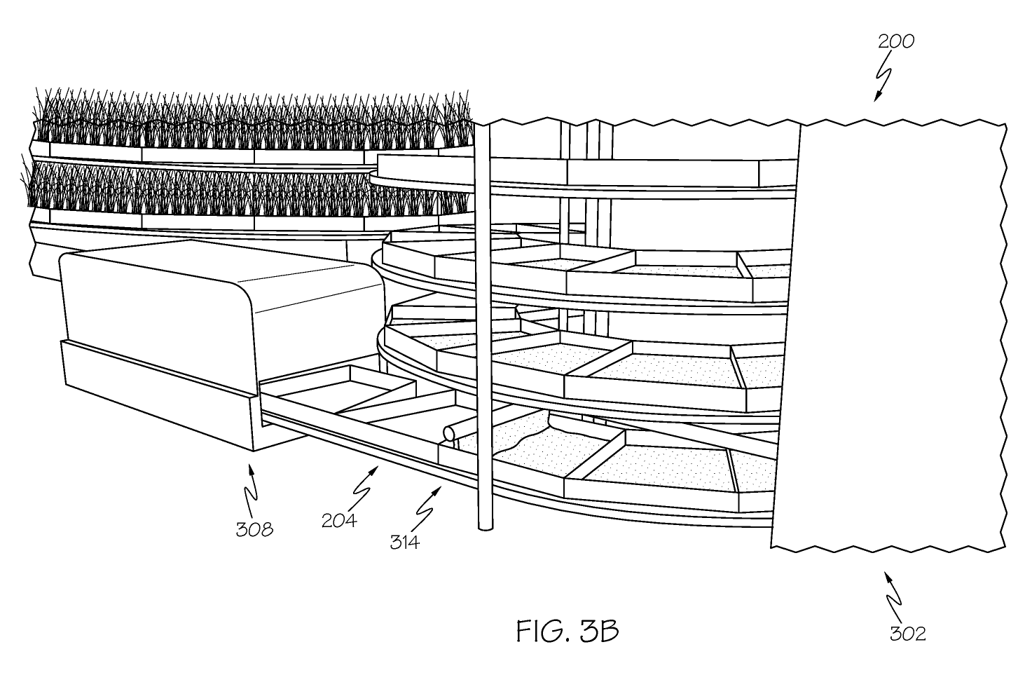

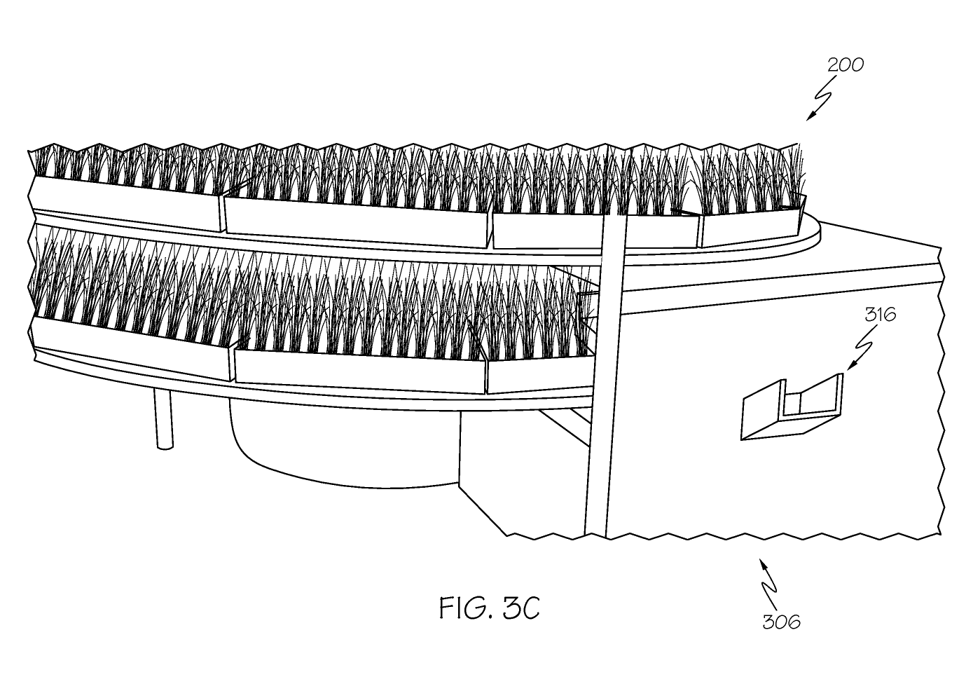

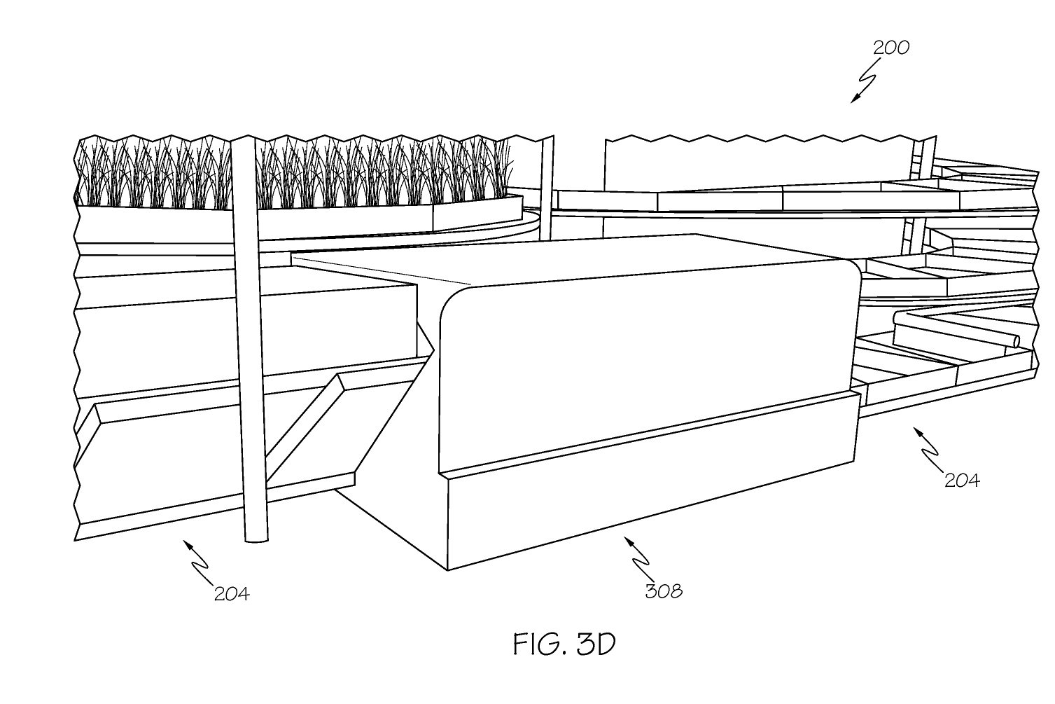

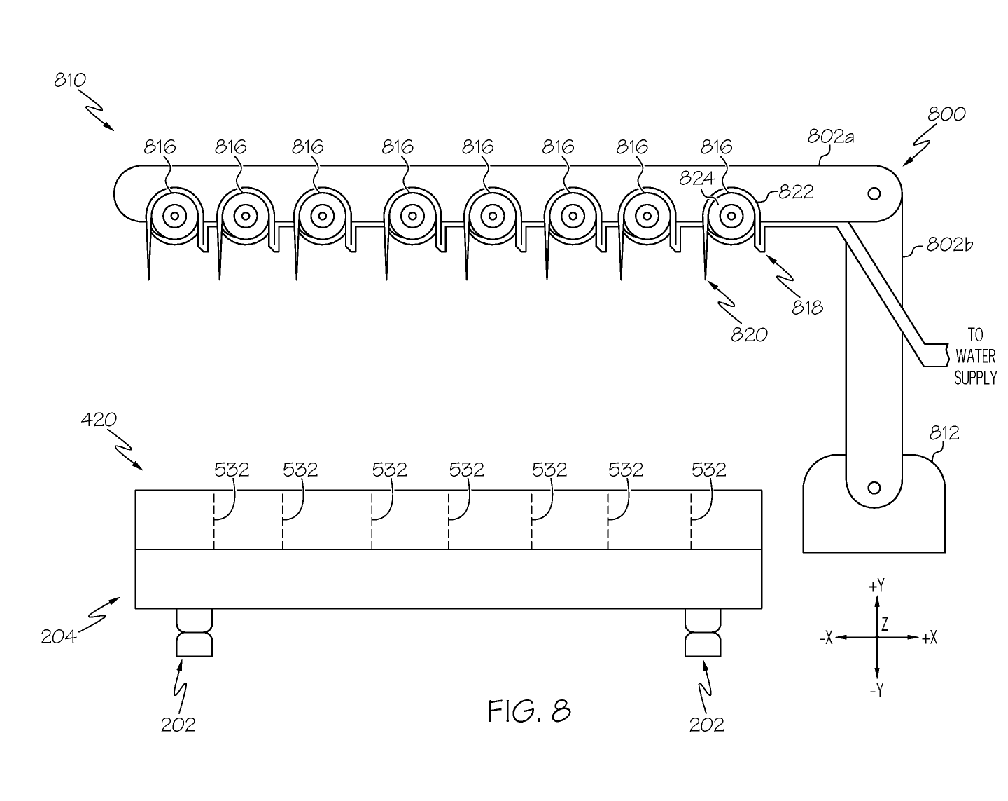

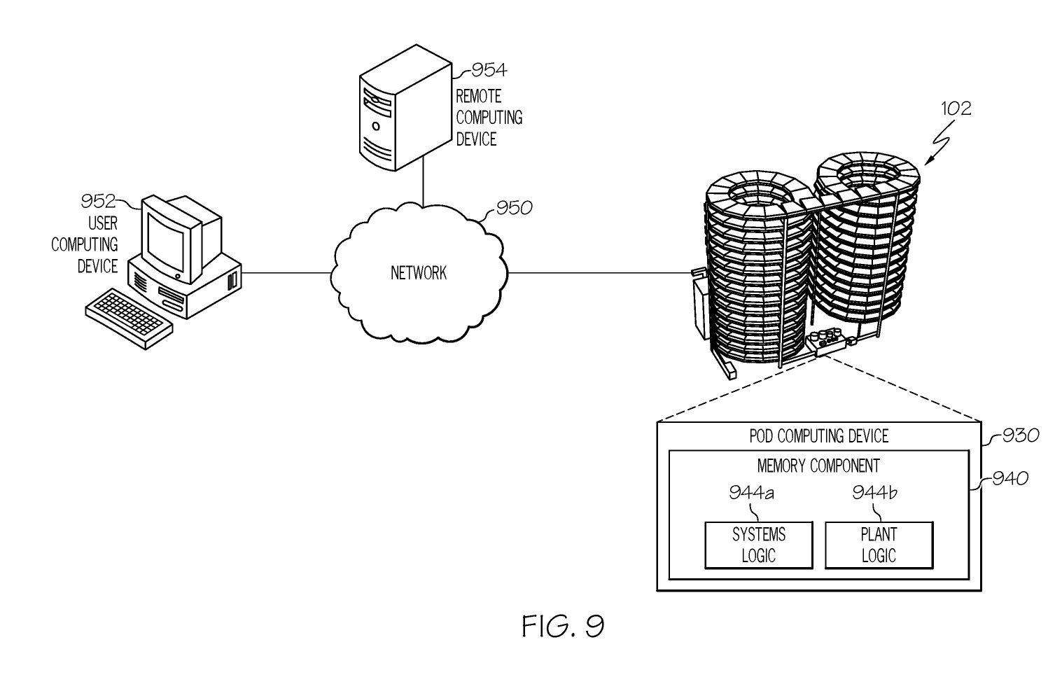

Also depicted in FIG. 2 is a master controller 106. The master controller 106 may include a computing device (such as pod computing device 930 in FIG. 9) and/or other components for controlling the assembly line grow pod 102. The assembly line grow pod 102 may also include one or more environment affecters, such as a lighting device 304 (FIG. 3A), pressure component, a heating component, a cooling component, a humidity component, an airflow component, seeder component 302 (FIG. 3A), a lighting device 304 (FIG. 3A), a harvester component 306 (FIG. 3A), a sanitizer component 308 (FIG. 3A), a sustenance component (FIG. 8), such as a nutrient dosing component and/or a water distribution component, and/or other hardware for altering the environment and/or controlling various components of the assembly line grow pod 102.

FIG. 2 depicts an interior portion 200 of the assembly line grow pod 102, according to embodiments described herein. As illustrated, the assembly line grow pod 102 may include a track 202 defines a path for one or more carts 204. The track 202 may be shaped into a plural of helixes, including an ascending portion 202a (defining a first helical structure or a first pillar), a descending portion 202b (defining a second helical structure or a second pillar), and a connection portion 202c. The track 202 may wrap around (in a counterclockwise direction in FIG. 2, although clockwise or other configurations are also contemplated) a first axis such that the carts 204 ascend upward in a vertical direction. The connection portion 202c may be relatively level (although this is not a requirement) and is utilized to transfer carts 204 to the descending portion 202b. The descending portion 202b may be wrapped around the second axis (again in a counterclockwise direction in FIG. 2) that is substantially parallel to the first axis, such that the carts 204 may be returned closer to ground level via a plurality of helical structures.

While not explicitly illustrated in FIG. 2, the assembly line grow pod 102 may also include a plurality of lighting devices 304, such as light emitting diodes (LEDs). The lighting devices 304 may be disposed on the track 202 opposite the carts 204, such that the lighting devices 304 direct light waves or photons to the carts 204 on the portion the track 202 directly below. In some embodiments, the lighting devices 304 are configured to create a plurality of different colors and/or wavelengths of light, depending on the application, the type of plant being grown, and/or other factors. While in some embodiments, LEDs are utilized for this purpose, this is not a requirement. Any lighting device 304 that produces photons with low heat inside the assembly line grow pod 102 and provides the desired functionality may be utilized.

Also depicted in FIG. 2 are airflow lines 212. Specifically, the master controller 106 may include and/or be coupled to one or more components that delivers airflow for temperature control, pressure, carbon dioxide control, oxygen control, nitrogen control, etc. Accordingly, the airflow lines 212 may distribute the airflow at predetermined areas in the assembly line grow pod 102.

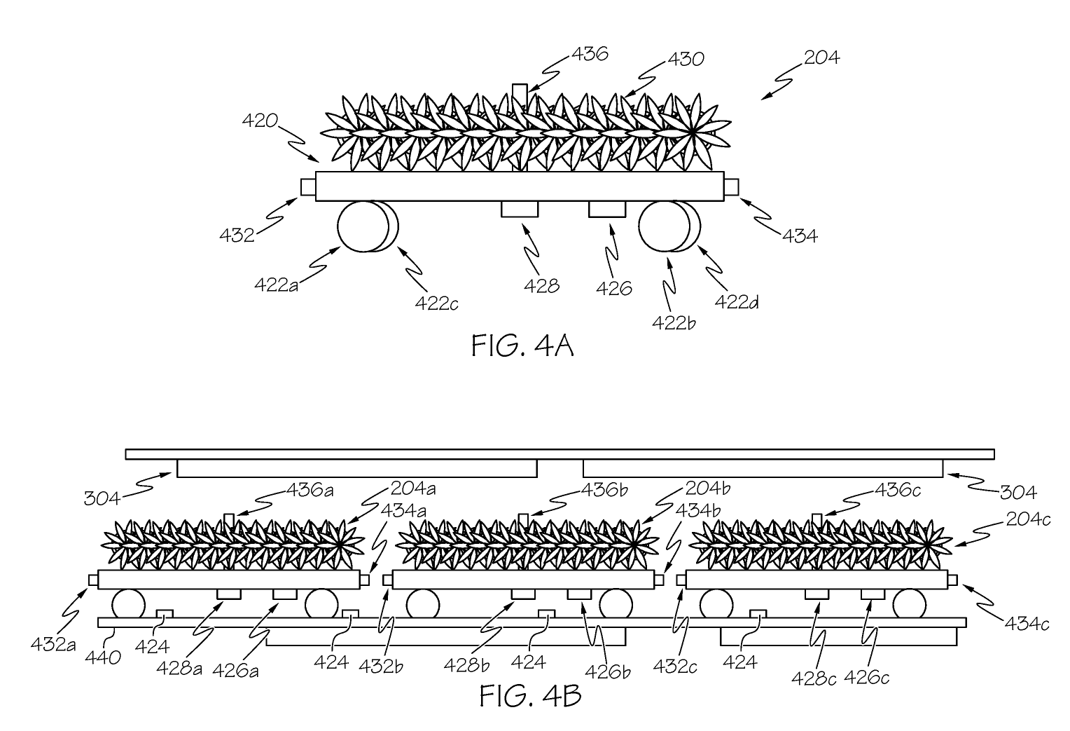

FIG. 3A depicts a plurality of components for an assembly line grow pod 102, according to embodiments described herein. As illustrated in FIG. 3A, the seeder component 302 is illustrated, as well as a lighting device 304, a harvester component 306, a sanitizer component 308 a watering component 310, and a nutrient dosing component 312. As described above, the seeder component 302 may be configured to seed one or more trays 420 (FIG. 4A) of the carts 204. As such, the seeder component 302 may include a reservoir of seeds and a seed dispensing component that dispenses seeds into a predetermined cell of the cart 204. The lighting device 304 (or lighting devices 304) may provide light waves that may facilitate plant growth. Depending on the particular embodiment, the lighting device 304 may be stationary and/or movable. As an example, some embodiments may alter the position of the lighting devices 304, based on the plant type, stage of development, recipe, and/or other factors.

The seeder component 302 may be configured to seed one or more carts 204 as the carts 204 pass the seeder component 302 in the assembly line. Depending on the particular embodiment, each cart 204 may include a single section tray for receiving a seed or plurality of seeds. Some embodiments may include a multiple section tray for receiving individual seeds in each section (or cell). In the embodiments with a single section tray, the seeder component 302 may detect presence of the respective cart 204 and may begin laying seed across an area of the single section tray. The seed may be laid out according to a desired depth of seed, a desired number of seeds, a desired surface area of seeds, and/or according to other criteria. In some embodiments, the seeds may be pre-treated with nutrients and/or anti-buoyancy agents (such as water) as these embodiments may not utilize soil to grow the seeds and thus might need to be submerged.

In the embodiments where a multiple section tray is utilized with one or more of the carts 204, the seeder component 302 may be configured to individually insert seeds into one or more of the sections of the tray 420 (FIG. 4). Again, the seeds may be distributed on the tray 420 (or into individual cells where a plant resides) according to a desired number of seeds, a desired area the seeds should cover, a desired depth of seeds, etc.

The watering component 310 may be coupled to one or more fluid lines 210 (FIG. 2), which distribute water and/or nutrients to one or more trays at predetermined areas of the assembly line grow pod 102. In some embodiments, seeds may be sprayed with a fluid to reduce buoyancy and/or flooded. Additionally, water usage and consumption may be monitored, such that at subsequent watering stations, this data may be utilized to determine an amount of water to apply to a seed (or remove from a cell) at that time.

The nutrient dosing component 312 may provide one or more of the seeds and/or plants with a predetermined nutrient and/or dosage of nutrients. As discussed in more detail below, some embodiments may provide at least one watering component 310 that is distinct from the nutrient dosing component 312. In some embodiments, one or more of the nutrient dosing components 312 may be integral with one or more watering components 310 to provide a single station or mechanism for providing both water and nutrients (such as depicted in FIG. 8).

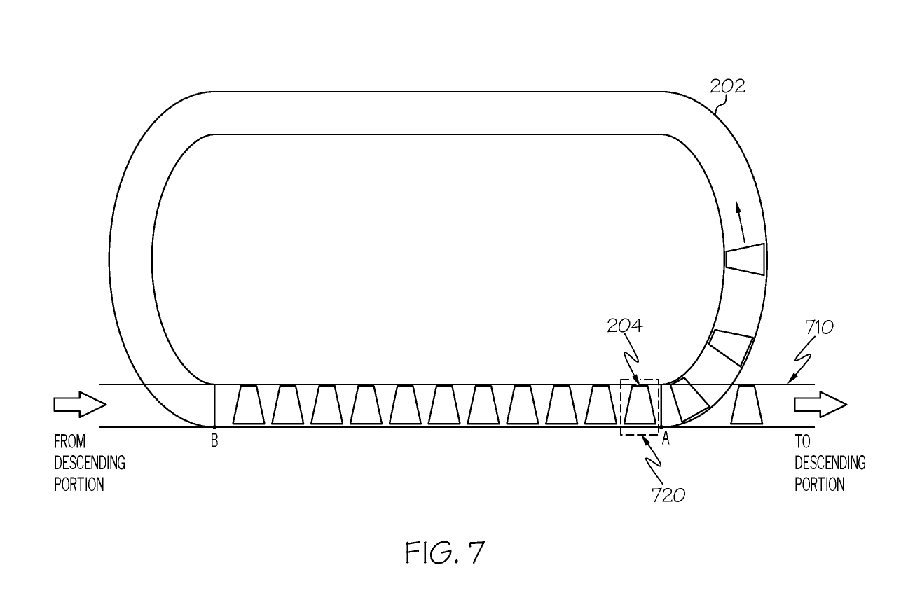

As the plants are lighted, watered, and provided nutrients, the carts 204 will traverse the track 202 of the assembly line grow pod 102. Additionally, the assembly line grow pod 102 may detect a current growth, a current development, and/or a current output of a plant and may determine when harvesting is warranted. If harvesting is warranted prior to the cart 204 reaching the harvester, modifications to a recipe may be made for that particular cart 204 until the cart 204 reaches the harvester component 306. Conversely, if a cart 204 reaches the harvester component 306 and it has been determined that the plants in that cart 204 are not ready for harvesting, the assembly line grow pod 102 may commission that cart 204 for another lap (discussed with reference to FIG. 7). This additional lap may include a different dosing of light, water, nutrients, etc. and the speed of the cart 204 could change, based on the development of the plants on the cart 204. If it is determined that the plants on a cart 204 are ready for harvesting, the harvester component 306 may facilitate that process.

In some embodiments, the harvester component 306 (FIG. 3A) may simply cut the plants at a predetermined height for harvesting. In some embodiments, the tray 420 may be overturned to remove the plants from the tray 420 and into a processing container for chopping, mashing, juicing, etc. Because many embodiments of the assembly line grow pod 102 do not use soil, minimal (or no) washing of the plants may be necessary prior to processing.

Similarly, some embodiments may be configured to automatically separate fruit from fruited plants, such as via shaking, combing, etc. If the remaining plant material may be reused to grow additional fruit, the cart 204 may keep the remaining plant and return to the growing portion of the assembly line. If the plant material is not to be reused to grow additional fruit, it may be discarded and/or processed, as appropriate.

Once the cart 204 and tray 420 (FIG. 4) are clear of plant material, the sanitizer component 308 may be implemented to remove any particulate, plant material, etc. that may remain on the cart 204. As such, the sanitizer component 308 may implement any of a plurality of different washing mechanisms, such as high pressure water, high temperature water, and/or other solutions for cleaning the cart 204 and/or tray 420. In some embodiments, the tray 420 may be overturned to output the plant for processing and the tray 420 may remain in this position. As such, the sanitizer component 308 may receive the tray 420 in this position, which may wash the cart 204 and/or tray and return the tray 420 back to the growing position. Once the cart 204 and/or tray 420 are cleaned, the cart 204 and tray 420 may again pass the seeder, which will determine that the tray 420 requires seeding and will begin the process of seeding.

FIG. 3B depicts a seeder component 302 for an assembly line grow pod 102, according to embodiments described herein. As discussed above, the sanitizer component 308 may return the tray 420 (FIG. 4) to the growing position, which is substantially parallel to ground. Additionally, a seeder head 314 may facilitate seeding of the tray 420 as the cart 204 passes under the seeder head 314. It should be understood that while the seeder head 314 is depicted in FIG. 3B as an arm that spreads a layer of seed across a width of the tray 420, this is merely an example. Some embodiments may be configured with a seeder head 314 that is capable of placing individual seeds in a desired location. Such embodiments may be utilized in a multiple section tray 420 with a plurality of cells, where one or more seeds may be individually placed in the cells.

FIG. 3C depicts a harvester component 306 for an assembly line grow pod 102 according to embodiments described herein. As illustrated, the carts 204 may traverse the track 202 to facilitate growth of the plants. Depending on the particular embodiment, the carts 204 may be individually powered and/or powered collectively. As an example, some embodiments are configured such that each cart 204 includes a motor, which is powered by a connection to the track 202. In these embodiments, the track 202 is electrified to provide power and/or communications to the cart 204. If a cart 204 malfunctions or becomes incapacitated, communication may be sent to other carts 204 to push the incapacitated cart 204. Similarly, some embodiments may include a cart 204 that is battery powered, such that a battery charging component may be included in the assembly line grow pod 102. The battery may be used as primary power and/or backup power.

Regardless, the carts 204 may traverse the track 202 to the harvester component 306 for cutting, chopping, dumping, juicing, and/or otherwise processing. Specifically, as the carts 204 enter the harvester component 306, the plants are removed from the cart and processed as defined in the grow recipe. The grow recipe may provide planned actuation of one or more environmental affecters and thus may instruct the harvester component 306 to simply remove and bag harvested plants. In some embodiments, the harvester component 306 may remove the plants from the carts 204 (such as by overturning the tray 420 into a bag). The bag may then be output via output port 316. Similarly, if the roots and stems are to be separated, a cutting mechanism may cut the plants to remove the stems from the roots. If the grow recipe indicates that at least a portion of the plants are to be powdered, the harvester component 306 may include the hardware utilized for removing, drying, and powdering the plants. Regardless of the particular output defined by the grow recipe, at least some embodiments are configured such that the harvester component 306 is configured to output the product ready to ship such that human hands have not contacted the product since (at least) entering the assembly line grow pod 102.

FIG. 3D depicts a sanitizer component 308 of an assembly line grow pod 102, according to embodiments described herein. As illustrated, the sanitizer component 308 may receive a cart 204 where the tray 420 (FIG. 4) has been overturned and/or may overturn the tray 420 itself. As described above, some embodiments may be configured such that the harvester component 306 overturns the trays 420 and, as such, the trays 420 may remain in that position when entering the sanitizer component 308. Regardless, the sanitizer component 308 may clean and/or otherwise sanitize the cart 204 and/or tray 420 and return the tray 420 to the grow position for receiving new seed.

Additionally, in some embodiments, the sanitizer component 308 may include one or more sensors for determining the cleanliness of the tray 420. If the sanitizer does not clean the tray 420 to a predetermined threshold, the master controller 106 may determine whether the tray is able to be cleaned to meet the threshold. If so, the cart 204 and tray 420 may be rerun through the sanitizer component 308. In some embodiments, the cart 204 may simply remain in the sanitizer component 308 while this determination and re-cleaning occur. In some embodiments, the cart 204 must recirculate at least a portion of the track 202 to return to the sanitizer component 308. If the sanitizer component 308 cannot clean the cart 204 and/or tray 420, the master controller 106 may decommission the cart 204 and introduce a new cart 204.

It should be understood that while the tray 420 may be overturned, this is merely an example. Specifically, some embodiments may desire to keep the cart 204 in contact with the track 202 to provide power, communication, and/or otherwise propel the cart 204 through the sanitizer component 308. As such, overturning only the tray 420 (and not the cart 204) may be desired in these embodiments. In some embodiments however, the sanitizer component 308 may operate without overturning the tray 420. Similarly, some embodiments may be configured such that both the tray 420 and cart 204 are overturned to facilitate cleaning.

It should also be understood that while the tray 420 may be overturned, this simply implies that the tray 420 is rotated such that a top surface is angled from level to allow particulate to fall from the tray 420. This may include rotating the tray 420 about 90 degrees, about 180 degrees, or rotating the tray 420 only a few degrees, depending on the embodiment.

FIGS. 4A, 4B depict a cart 204 for receiving plants and seeds in an assembly line grow pod 102, according to embodiments described herein. As illustrated in FIG. 4A, the cart 204 may support a payload 430 (such as plants and/or seeds) and include a plurality of wheels 422a, 422b, 422c, 422d for supporting the payload 430 on the track 202. The cart 204 may additionally include a tray 420 that holds the payload 430, as well as drive motor 426, a cart computing device 428, a leading sensor 432, a trailing sensor 434, and an orthogonal sensor 436. The drive motor 426 may be configured to receive power (such as from the track 202) to power the wheels 422a-422d. The cart computing device 428 may be configured to communicate with the master controller 106 and/or provide other functionality provided herein. The leading sensor 432 and the trailing sensor 434 may be configured to provide information related to a leading cart 204a and a trailing cart 204b (FIG. 4B). The orthogonal sensor 436 may provide location data and/or other data based on markers or other data above the cart 204.

FIG. 4B depicts a plurality of illustrative carts 204 (e.g., the first cart or leading cart 204a, a second cart or cart 204b, and a third cart or trailing cart 204c), each supporting a payload 430 in an assembly line configuration on the track 202 is depicted. In some embodiments, the track 202 may include one rail 440 that is in electrical contact with at least one wheel 422. In such an embodiment, the wheel 422 may relay communication signals and electrical power to the cart 204 as the cart 204 travels along the track 202.

In some embodiments, the track 202 may include two conductive rails. The conductive rails may be coupled to an electrical power source. The electrical power source may be a direct current source or an alternating current source. For example, one or more of the rails 440 may be electrically coupled to one of the two poles (e.g., a negative pole and a positive pole) of the direct current source or the alternating current source. In some embodiments, one of the rails 440 supports a first pair of wheels 422 (e.g., 422a and 422b) and the other one of the rails 440 supports a second pair of wheels 422 (e.g., 422c and 422d). As such, at least one wheel 422 from each pair of wheels are in electrical contact with the rails 440 so that the cart 204 and the components therein may receive electrical power and/or communication signals transmitted over the track 202 as the cart 204 moves along the track 202. Backup power supplies may also be provided for powering the carts 204a, 204b, 204c.

The communication signals and electrical power may include an encoded address specific to a particular cart 204. Each cart 204 may include a unique address such that multiple communications signals and electrical power signal may be transmitted over the same track 202 and each signal may be received by the intended recipient of that signal. For example, the assembly line grow pod 102 may implement a digital command control system (DCC). The DDC system may encode a digital packet having a command and an address of an intended recipient, for example, in the form of a pulse width modulated signal that is transmitted along with electrical power to the track 202.

In such an embodiment, each cart 204 may include a decoder, which may include or be coupled to a cart computing device 428. When the decoder receives a digital packet corresponding to its unique address, the decoder executes the embedded command. In some embodiments, the cart 204 may also include an encoder, which may be included in or coupled to the cart computing device 428, for generating and transmitting communications signals from the cart 204. The encoder may cause the cart 204 to communicate with other industrial carts 204 positioned along the track 202 and/or other devices or computing devices communicatively coupled with the track 202.

While the implementation of a DCC system is disclosed herein as an example of providing communication signals and/or electrical power to a designated recipient along a common interface (e.g., the track 202), any system and method capable of transmitting communication signals along with electrical power to and from a specified recipient may be implemented. For example, some embodiments may be configured to transmit data over AC circuits by utilizing a zero-crossing of the power from negative to positive (or vice versa).

In embodiments that include a system using alternating current to provide electrical power to the industrial carts 204, the communication signals may be transmitted to the cart 204 during a zero-crossing of the alternating current sine wave. That is, the zero-crossing is the point at which there is no voltage present from the alternating current power source. As such, a communication signal may be transmitted during this interval.

Therefore, in such embodiments, during a first zero-crossing interval, a communication signal may be transmitted to and received by the cart computing device 428 of the cart 204. The communication signal transmitted during the first zero-crossing interval may include a command and a direction to execute the command when a subsequent command signal is received and/or at a particular time in the future. During a subsequent zero-crossing interval, a communication signal may include a synchronization pulse, which may indicate to the cart computing device 428 of the cart 204 to execute the previously received command. The aforementioned communication signal and command structure is only an example. As such, other communication signals and command structures or algorithms may be employed within the spirit and scope of the present disclosure.

In embodiments that use alternating current to provide electrical power to the industrial carts 204, the communication signals may be transmitted to the cart 204 during the zero-crossing of the alternating current sine wave. In some embodiments, a communication signal may be defined by the number of AC waveform cycles, which occur between a first trigger condition and a second trigger condition. In some embodiments, the first and second trigger condition, which may be the presence of a pulse (e.g., a 5 volt pulse) may be introduced in the power signal during the zero-crossing of the AC electrical power signal. In some embodiments, the first and second trigger condition may be or a change in the peak AC voltage of the AC electrical power signal.

For example, the first trigger condition may be the change in peak voltage from 18 volts to 14 volts and the second trigger condition may be the change in peak voltage from 14 volts to 18 volts. The cart computing device 428 may be electrically coupled to the wheels 422 and may be configured to sense changes in the electrical power signal transmitted over the track 202 and through the wheels 422. When the cart computing device 428 detects a first trigger condition, the cart computing device 428 may begin counting the number of peak AC voltage levels, the number of AC waveform cycles, or the amount of time until a second trigger condition is detected.

In some embodiments, the count corresponds to a predefined operation or communication message. For example, a 5 count may correspond to an instruction for powering on the drive motor 426 and an 8 count may correspond to an instruction for powering off the driver motor 426. Each of the instructions may be predefined in the cart computing devices 228 of the industrial carts 204 so that the cart computing device 428 may translate the count into the corresponding instruction and/or control signal. The aforementioned communication signals and command structures are only examples. As such, other communication signals, command structures, and/or algorithms may be employed within the spirit and scope of the present disclosure.

In some embodiments, bi-directional communication may occur between the cart computing device 428 of the cart 204 and the master controller 106. In some embodiments, the cart 204 may generate and transmit a communication signal through the wheel 422 and the track 202 to the master controller 106. In some embodiments, transceivers may be positioned anywhere on the track 202. The transceivers may communicate via infrared or other near-field communication system with one or more industrial carts 204 positioned along track 202. The transceivers may be communicatively coupled with the master controller 106 or another computing device, which may receive a transmission of a communication signal from the cart 204.

In some embodiments, the cart computing device 428 may communicate with the master controller 106 using a leading sensor 432a-432c, a trailing sensor 434a-434c, and/or an orthogonal sensor 436a-436c included on the cart 204. Collectively, the leading sensors 432a-432c, trailing sensors 434a-234c, and orthogonal sensors 436a-236c are referred to as leading sensors 432, trailing sensors 434, and orthogonal sensors 436, respectively. The sensors 432, 434, 436 may be configured as a transceiver or include a corresponding transmitter module. In some embodiments, the cart computing device 428 may transmit operating information, status information, sensor data, and/or other analytical information about the cart 204 and/or the payload 430 (e.g., plants growing therein). In some embodiments, the master controller 106 may communicate with the cart computing device 428 to update firmware and/or software stored on the cart 204.

Since the carts 204 are limited to travel along the track 202, the area of track 202 a cart 204 will travel in the future is referred to herein as “in front of the cart” or “leading.” Similarly, the area of track 202 a cart 204 has previously traveled is referred to herein as “behind the cart” or “trailing.” Furthermore, as used herein, “above” refers to the area extending from the cart 204 away from the track 202 (i.e., in the +Y direction of the coordinate axes of FIG. 3). “Below” refers to the area extending from the cart 204 toward the track 202 (i.e., in the −Y direction of the coordinate axes of FIG. 3).

Still referring to FIG. 4B, one or more components may be coupled to the tray 420. For example, each cart 204a-104c may include a back-up power supply, a drive motor 426, a cart computing device 428, a tray 420 and/or the payload 430. Collectively, the back-up power supplies, drive motors 426, and cart computing devices 428 are referred to as back-up power supply, drive motor 426, and cart computing device 428. The tray 420 may additionally support a payload 430 thereon. Depending on the particular embodiment, the payload 430 may contain plants, seedlings, seeds, etc. However, this is not a requirement as any payload 430 may be carried on the tray 420 of the cart 204.

The back-up power supply may comprise a battery, storage capacitor, fuel cell or other source of reserve electrical power. The back-up power supply may be activated in the event the electrical power to the cart 204 via the wheels 422 and track 202 is lost. The back-up power supply may be utilized to power the drive motor 426 and/or other electronics of the cart 204. For example, the back-up power supply may provide electrical power to the cart computing device 428 or one or more sensors. The back-up power supply may be recharged or maintained while the cart is connected to the track 202 and receiving electrical power from the track 202.

The drive motor 426 is coupled to the cart 204. In some embodiments, the drive motor 426 may be coupled to at least one of the one or more wheels 422 such that the cart 204 is capable of being propelled along the track 202 in response to a received signal. In other embodiments, the drive motor 426 may be coupled to the track 202. For example, the drive motor 426 may be rotatably coupled to the track 202 through one or more gears, which engage a plurality of teeth, arranged along the track 202 such that the cart 204 is propelled along the track 202. That is, the gears and the track 202 may act as a rack and pinion system that is driven by the drive motor 426 to propel the cart 204 along the track 202.

The drive motor 426 may be configured as an electric motor and/or any device capable of propelling the cart 204 along the track 202. For example, the drive motor 426 may be configured as a stepper motor, an alternating current (AC) or direct current (DC) brushless motor, a DC brushed motor, or the like. In some embodiments, the drive motor 426 may comprise electronic circuitry, which may be used to adjust the operation of the drive motor 426, in response to a communication signal (e.g., a command or control signal for controlling the operation of the cart 204) transmitted to and received by the drive motor 426. The drive motor 426 may be coupled to the tray 420 of the cart 204 or may be directly coupled to the cart 204. In some embodiments, more than one drive motor 426 may be included on the cart 204. For example, each wheel 422 may be rotatably coupled to a drive motor 426 such that the drive motor 426 drives rotational movement of the wheels 422. In other embodiments, the drive motor 426 may be coupled through gears and/or belts to an axle, which is rotatably coupled to one or more wheels 422 such that the drive motor 426 drives rotational movement of the axle that rotates the one or more wheels 422.

In some embodiments, the drive motor 426 is electrically coupled to the cart computing device 428. The cart computing device 428 may electrically monitor and control the speed, direction, torque, shaft rotation angle, or the like, either directly and/or via a sensor that monitors operation of the drive motor 426. In some embodiments, the cart computing device 428 may electrically control the operation of the drive motor 426. In some embodiments, the cart computing device 428 may receive a communication signal transmitted through the electrically coupled track 202 and the one or more wheels 422 from the master controller 106 or other computing device communicatively coupled to the track 202. In some embodiments, the cart computing device 428 may directly control the drive motor 426 in response to signals received through network interface hardware. In some embodiments, the cart computing device 428 executes power logic to control the operation of the drive motor 426.

Still referring to FIG. 4B, the cart computing device 428 may control the drive motor 426 in response to one or more signals received from a leading sensor 432, a trailing sensor 434, and/or an orthogonal sensor 436 included on the cart 204 in some embodiments. Each of the leading sensor 432, the trailing sensor 434, and the orthogonal sensor 436 may comprise an infrared sensor, a photo-eye sensor, a visual light sensor, an ultrasonic sensor, a pressure sensor, a proximity sensor, a motion sensor, a contact sensor, an image sensor, an inductive sensor (e.g., a magnetometer) or other type of sensor capable of detecting at least the presence of an object (e.g., another cart 204 or a location marker 424) and generating one or more signals indicative of the detected event (e.g., the presence of the object).

As used herein, a “detected event” refers to an event for which a sensor is configured to detect. In response, the sensor may generate one or more signals corresponding to the event. For example, if the sensor is configured to generate one or more signals in response to the detection of an object, the detected event may be the detection of an object. Moreover, the sensor may be configured to generate one or more signals that correspond to a distance from the sensor to an object as a distance value, which may also constitute a detected event. As another example, a detected event may be a detection of infrared light. In some embodiments, the infrared light may be generated by the infrared sensor reflected off an object in the field of view of the infrared sensor and received by the infrared sensor.

In some embodiments, an infrared emitter may be coupled to the cart 204 or in the environment of the assembly line grow pod 102, and may generate infrared light which may be reflected off an object and detected by the infrared sensor. In some instances, the infrared sensor may be calibrated to generate a signal when the detected infrared light is above a defined threshold value (e.g., above a defined power level). In some embodiments, a pattern (e.g. a barcode or QR code) may be represented in the reflected infrared light, which may be received by the infrared sensor and used to generate one or more signals indicative of the pattern detected by the infrared sensor. The aforementioned is not limited to infrared light. Various wavelengths of light, including visual light, such as red or blue, may also be emitted, reflected, and detected by a visual light sensor or an image sensor that generates one or more signals in response to the light detection. As an additional example, a detected event may be a detection of contact with an object (e.g., as another cart 204) by a pressure sensor or contact sensor, which generates one or more signals corresponding thereto.

In some embodiments, the leading sensor 432, the trailing sensor 434, and the orthogonal sensor 436 may be communicatively coupled to the cart computing device 428. The cart computing device 428 may receive the one or more signals from one or more of the leading sensor 432, the trailing sensor 434, and the orthogonal sensor 436. In response to receiving the one or more signals, the cart computing device 428 may execute a function. For example, in response to the one or more signals received by the cart computing device 428, the cart computing device 428 may adjust, either directly or through intermediate circuitry, a speed, a direction, a torque, a shaft rotation angle, and/or the like of the drive motor 426.

In some embodiments, the leading sensor 432, the trailing sensor 434, and/or the orthogonal sensor 436 may be communicatively coupled to the master controller 106 (FIG. 2). In some embodiments, the leading sensor 432, the trailing sensor 434, and the orthogonal sensor 436 may generate one or more signals that may be transmitted via the one or more wheels 422 and the track 202.

Still referring to FIG. 4B, the signals from one or more of the leading sensor 432, the trailing sensor 434, and the orthogonal sensor 436 may directly adjust and control the drive motor 426 in some embodiments. For example, electrical power to the drive motor 426 may be electrically coupled with a field-effect transistor, relay, or other similar electronic device capable of receiving one or more signals from a sensor. For example, electrical power to the drive motor 426 may be electrically coupled via a contact sensor that selectively activates or deactivates the operation of the drive motor 426 in response to the one or more signals from the sensor.

That is, if a contact sensor electromechanically closes (e.g., the contact sensor contacts an object, such as another cart 204), then the electrical power to the drive motor 426 is terminated. Similarly, when the contact sensor electromechanically opens (e.g., the contact sensor is no longer in contact with the object), then the electrical power to the drive motor 426 may be restored. This may be accomplished by including the contact sensor in series with the electrical power to the drive motor 426 or through an arrangement with one or more electrical components electrically coupled to the drive motor 426. In other embodiments, the operation of the drive motor 426 may adjust proportionally to the one or more signals from the one or more sensors 432, 434, and 436. For example, an ultrasonic sensor may generate one or more signals indicating the range of an object from the sensor and as the range increases or decreases, the electrical power to the drive motor 426 may increase or decrease, thereby increasing or decreasing the output of the drive motor 426 accordingly.

The leading sensor 432 may be coupled to the cart 204 such that the leading sensor 432 detects adjacent objects, such as another cart 204 in front of or leading the cart 204. In addition, the leading sensor 432 may be coupled to the cart 204 such that the leading sensor 432 communicates with other sensors 432, 434, and 436 coupled to another cart 204 that are in front of or leading the cart 204. The trailing sensor 434 may be coupled to the cart 204 such that the trailing sensor 434 detects adjacent objects, such as another cart 204 behind or trailing the cart 204. In addition, the trailing sensor 434 may be coupled to the cart 204 such that the trailing sensor 434 communicates with other sensors 432, 434, and 436 coupled to another cart 204 that are behind or trailing the cart 204.

The orthogonal sensor 436 may be coupled to the cart 204 to detect or communicate with adjacent objects, such as location markers 424, positioned above, below, and/or beside the cart 204. While FIG. 4B depicts the orthogonal sensor 436 positioned generally above the cart 204, as previously stated, the orthogonal sensor 436 may be coupled with the cart 204 in any location which allows the orthogonal sensor 436 to detect and/or communicate with objects, such as a location marker 424, above and/or below the cart 204.

Still referring to FIG. 4B, it should be understood that the leading sensors 432 and the trailing sensors 434 are depicted on a leading side and a trailing side of each of the industrial carts 204, respectively. However, this is merely an example. Depending on the types of devices utilized, the leading sensors 432 may be located anywhere on the industrial carts 204. Similarly, depending on the types of devices utilized for the trailing sensor 434, these devices may be positioned anywhere on the industrial carts 204. While some devices require line of sight, this is not a requirement.

In addition, the orthogonal sensors 436 are depicted in FIG. 4B as being directed substantially upward. This is also merely an example, as the orthogonal sensors 436 may be directed in any appropriate direction to communicate with the master controller 106. In some embodiments, the orthogonal sensors 436 may be directed below the cart 204, to the side of the industrial carts 204, and/or may not require line of sight and may be placed anywhere on the industrial carts 204 (e.g., in embodiments where the orthogonal sensors 436 utilize a radio frequency device, a near-field communication device, or the like).

In some instances, the drive motor 426 of the middle cart 204b may malfunction. In such a case, the middle cart 204b may utilize the trailing sensor 434b to communicate with the trailing cart 204c that the drive motor 426b of the middle cart 204b has malfunctioned. In response, the trailing cart 204c may push the middle cart 204b. To accommodate the extra load in pushing the middle cart 204b, the trailing cart 204c may adjust its operation mode (e.g., increase the electrical power to the drive motor 426 of the trailing cart 204c). The trailing cart 204c may push the middle cart 204b until the malfunction has been repaired or the middle cart 204b is replaced. In some embodiments, the middle cart 204b may comprise a slip clutch and gear arrangement coupled to the drive motor 426b and the track 202. As such, when the trailing cart 204c begins pushing the middle cart 204b the slip clutch and gear arrangement may disengage from the track 202 such that the middle cart 204b may be propelled along the track 202. This allows the middle cart 204b to be freely pushed by the trailing cart 204c. The slip clutch may reengage with the track 202 once the malfunction is corrected and the trailing cart 204c stops pushing.

As will be understood, the leading sensor 432a of the leading cart 204a and the trailing sensor 434c of the trailing cart 204c may be configured to communicate with other industrial carts 204 that are not depicted in FIG. 3. Similarly, some embodiments may cause the leading sensor 432b to communicate with the trailing sensor 434a of the leading cart 204a to pull the middle cart 204b in the event of a malfunction. Additionally, some embodiments may cause the industrial carts 204 to communicate status and other information, as desired or necessary.

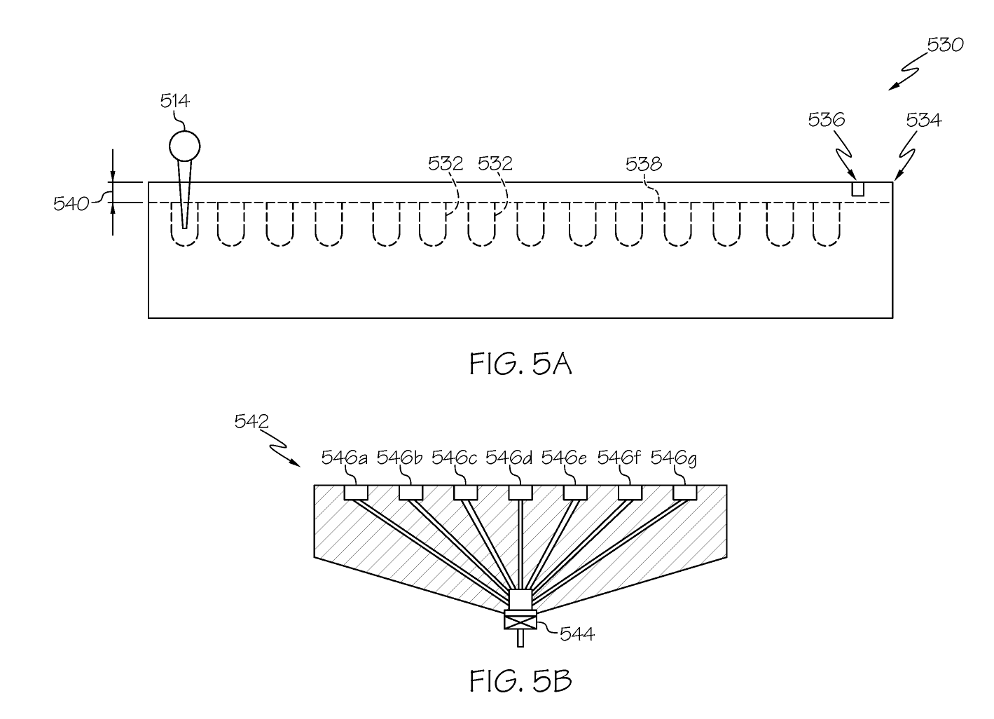

FIGS. 5A, 5B depict various configurations of a bed seed holder 530, according to embodiments described herein. As illustrated in FIG. 5A, a bed seed holder 530 may reside on a cart 204 and may include a flange 534 and a spigot 536, according to embodiments described herein. As illustrated, the bed seed holder 530 may include a plurality of cells 532 that extend from a crown surface 538 (depicted with dashed lines to indicate that the plurality of cells 532 and the crown surface 538 would not be visible from this perspective). Also depicted is a flange 534, which allows water to pool outside of the cells 532 and above the crown surface 538. The flange 534 is also positioned to maintain a desired water level in the bed seed holder 530. A distance between the crown surface 538 and the flange 534 defines an elevation envelope 540. Because the flange 534 extends to a height greater than the spigot 536, the flange 534 may generally maintain the level of the water above the crown surface 538, including when water spills across the bed seed holder 530, for example, due to movement of the bed seed holder 530 along the assembly line grow pod 102.

As discussed above, the spigot 536 may be positioned at a vertical height above the cells 532 and/or may be positioned at a vertical height below the bottom of the cells (as shown in FIG. 5B). The spigot 536 may be selectable and controllable in some embodiments to maintain a desired water level in the bed seed holder 530 and/or in a predetermined cell of the cells 532. As an example, some embodiments may be configured to close or partially close a spigot 536 in response to a desired height to maintain a higher water level. When the water is to be drained or otherwise removed, the spigot 536 (which may extend down to the cells 532 in this embodiment) may open to allow the water to drain. Similarly, some embodiments may be configured such that one or more of the cells 532 includes a spigot for draining water from individual cells. The spigot 536 maintains the level of the water at a vertical height that is less than the elevation envelope 540.

The bed seed holder 530 may include a water level sensor 514 that determines the level of the water in at least one of the cells 532, as described below. The water level sensor 514 forms part of the watering component, and may be used in evaluating the water that is present in the sampled cell 532. Examples of such water level sensors including, for example and without limitation, a float switch, a magnetic switch, an RF switch, a thermal dispersion sensor, a magnetic level gauge, a magnetorestrictive gauge, an RF transmitter, a radar sensor, a camera, an ultrasonic sensor, and/or other sensor for detecting water and/or excess water. The water level sensor 114 may be in electronic communication with the cart computing device 428, the master controller 106, and/or other computing device that monitors the level of water in the bed seed holder 530 and/or the water absorption of the associated plant, and initiates distribution of additional water from the watering component or release of water from the selectable spigot 536.

As illustrated in FIG. 5B, embodiments a bed seed holder 542 may include a spigot 544 that is selectable to control the release of water from one or more of the cells 546a-546g. The spigot 544 may be in fluid communication with all or a portion of the cells 546, such that fluid may be drawn from may be disposed on the flange to prevent water from pooling too deeply. In some embodiments, the spigot 544 may be in electronic communication with the computing device 428, the master controller 106, and/or other computing device that controls selective opening of the spigot 544.

The spigot 544 may be controlled to manage the level of water in the cell 546 throughout the growth cycle of the plant type For example, in some plant types, the presence of too much water when the plant is a seed or a seedling may lead to adverse pressures on the plant. Therefore, during these portions of the growth cycle, the spigots 536, 544 may be controlled to allow water to be drained away from the seed or seedling, thereby preventing water from undesirably pooling around the seed or seedling. In contrast, as the seedling progresses in maturity, the plant may benefit from higher quantities of water being present. During these portions of the growth cycle, the spigots 336 may be controlled to allow water to be maintained in the cells 546 to enhance growth of the plant. In some embodiments, the spigot 544 may be an electronically controlled valve, for example, a solenoid valve, that selectively opens or closes, thereby allowing water to exit the cells 546 that are in fluid communication with the electronically controlled valve.

In various embodiments, the spigot 544 may control the rate of water removal from the cell 532. In some embodiments, the spigot 536 may be selected to have a high rate of water removal from the cell 546 at times corresponding to periods of the plant's growth cycle in which excess water is undesired and may be selected to have a low rate of water removal from the cell at time corresponding to periods of the plant's growth cycle in which additional water is desired. In such an embodiment, the spigot 544 may include an adjustable nozzle that increases in size to allow for an increased flow rate of water and decreases in size to allow for a decreased flow rate of water. In some embodiments, the bed seed holder 542 may include a wicking media (not shown) that extends into each of the cells 546 of the bed seed holder 542, and allows water to flow into the cells 546 or out of the cells 546 based on the position of the wicking media and the relative moisture levels at positions along the wicking media.

It should also be understood that while, the embodiments of FIGS. 5A, 5B each depict a single spigot 536, 544, this is merely one example. Some embodiments may be configured with a plurality of spigots and/or spigots for each cell to individually control water to each plant and/or cell.

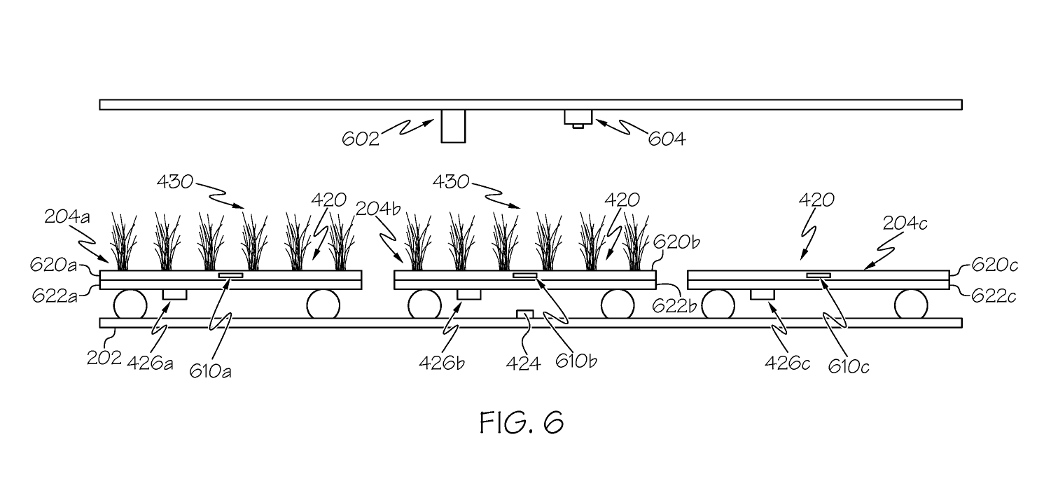

FIG. 6 depicts a plurality of carts 204 on a track 202 of an assembly line grow pod 102, according to embodiments described herein. Carts 204a, 204b, and 204c move along the track 202 in +x direction through wheels. The cart 204a includes an upper plate 620a and a lower plate 622a. The cart 204b includes an upper plate 620b and a lower plate 622b. The cart 204c includes an upper plate 620c and a lower plate 622c.

In embodiments, the carts 204a, 204b, and 204c include weight sensors 610a, 610b, and 610c, respectively. Each of the weight sensors 610a, 610b, and 610c may be placed in the upper plates 620a, 620b, 620c of the carts 204a, 204b, and 204c, respectively. The weight sensors 610a, 610b, and 610c are configured to measure the weight of a payload 430 on the carts 204, such as plants. The cart computing devices 428 (FIG. 4A) may be communicatively coupled to the weight sensors 610a, 610b, and 610c and receive weight information from the weight sensors 610a, 610b, and 610c. The cart computing devices 428 may also be configured for communicating with the master controller 106. The cart computing device 428 and/or the master controller 106 may determine whether the measured weight is greater than a threshold weight. The threshold value may be determined based on the type and developmental state of the plant.

If it is determined that the measured weight is greater than the threshold weight, the master controller 106 may send an instruction to a lifter component of the assembly line grow pod 102 to raise the upper plate to discard the payload 430 from the cart 204, and/or send an instruction to an actuator to rotate the upper plate 620. In some embodiments, each of the carts 204a, 204b, and 204c may include a plurality of weight sensors corresponding to a plurality of cells of the carts 204a, 204b, and 204c. The plurality of weight sensors 610 may determine weights of individual cells or plants on the carts 104b.

In some embodiments, a plurality of weight sensors may be placed on the track 202. The weight sensors are configured to measure the weights of the carts on the track 202 and transmit the weights to the master controller 106. The master controller 106 may determine the weight of payload 430 on a cart by subtracting the weight of the cart from the weight received from the weight sensors on the track 202.

A proximity sensor 602 may be positioned over the carts 204a, 204b, and 204c. In embodiments, the proximity sensor 602 may be attached under an upper portion of the track 202 as depicted in FIG. 6. The proximity sensor 602 may be configured to measure a distance between the proximity sensor 602 and the plants on the carts 204. For example, the proximity sensor 602 may transmit waves and receive waves reflected from the plants. Based on the travelling time of the waves, the proximity sensor 602 may determine the distance between the proximity sensor and the plants. In some embodiments, the proximity sensor 602 may be configured to detect an object within a certain distance. For example, the proximity sensor 602 may detect the payload 430 in the carts 104b if the payload 430 is within 5 inches from the proximity sensor 602. In some embodiments, the proximity sensor 602 may include laser scanners, capacitive displacement sensors, Doppler Effect sensors, eddy-current sensors, ultrasonic sensors, magnetic sensors, optical sensors, radar sensors, sonar sensors, LIDAR sensors or the like. Some embodiments may not include the proximity sensor 602.

The proximity sensor 602 may have wired and/or wireless network interface for communicating with the master controller 106. The master controller 106 may determine the height of payload 430 on the cart 204 based on the measured distance. For example, the master controller 106 calculates a height of payload 430 by subtracting the measured distance from a distance between the proximity sensor 602 and the upper plate 620b of the industrial cart 204b. The master controller 106 may determine whether the calculated height is greater than a threshold height. The threshold height may be determined based on a plant. For example, the master controller 106 may store a name of plant and corresponding threshold height.

If it is determined that the calculated height is greater than the threshold height, the master controller 106 may send an instruction to rotate the tray 420 to raise the upper plate 620 to discard the payload 430 from the cart 204b. In some embodiments, a plurality of proximity sensors 602 may measure distances between the proximity sensors and the payload 430, and transmit the distances to the master controller 106. The master controller 106 calculates an average height of the payload 430 based on the received distances from the plurality of proximity sensors 602 and determines whether the average height is greater than the threshold height.

A camera 604 may be positioned over the carts 204a, 204b, and 204c. In embodiments, the camera 604 may be attached under an upper portion of the track 202 as depicted in FIG. 6. The camera 604 may be configured to capture an image of the plants in the cart 204b. The camera 604 may have a wider angle lens to capture plants of more than one cart 204. For example, the camera 604 may capture the images of payload 430 in the carts 204a, 204b, and/or 204c. The camera 604 may include an optical filter that filters out artificial LED lights from lighting devices in the assembly line grow pod 102 such that the camera 604 may capture the natural colors of the plants.

The camera 604 may transmit the captured image of the payload 430 to the master controller 106. The camera 604 may have a wired and/or wireless network interface for communicating with the master controller 106. The master controller 106 may determine whether payload 430 is ready to harvest based on the color of the captured image. In some embodiments, the master controller 106 may compare the color of the captured image with a threshold color for the identified plant on the cart 204. The predetermined color for one or more plants may be stored by the master controller 106. For example, the master controller 106 compares RGB levels of the captured image with the RGB levels of the predetermined color, and determines that the plant is ready to harvest based on the comparison.

While FIGS. 4B and 6 depict different features on the carts 204, this is merely an embodiment. Some embodiments may include all of the features from FIGS. 4B, 6, and features described elsewhere herein. Similarly, some embodiments may utilize a portion of those features, but are not limited to a particular drawing or embodiment.

FIG. 7 depicts an overhead view of a bypass configuration for a track 202 of an assembly line grow pod 102, according to embodiments described herein. The assembly line grow pod 102 includes a secondary track 710 in addition to the track 202 which is a primary track 202. The secondary track 710 may start at point A and connect with another portion of the primary track 202. At point A, the primary track 202 is bifurcated into the primary track 202 and the secondary track 710. After point A, the secondary track 710 may connect with a different pillar or other point on the assembly line grow pod 102. At point B, a portion of the secondary track 710 from another pillar or area is merged into the primary track 202. The total length of the secondary track 710 may be shorter than the total length of the primary track 202. For example, the total length of a section of the secondary track 710 may be about 1/12 of the total length of the primary track 202, about 1/6 of the total length of the primary track 202, about 1/3 of the total length of the primary track 202, etc. and may reconnect with another section of primary track 202 at a different location (such as at another track pillar), thus creating another connection portion 202c (FIG. 2) of track. In some embodiments, the connection portion 202c is replicated with a plurality of secondary track 710 sections connecting two (or more) pillars at a plurality of different points, thereby creating several different paths that a cart can traverse.

In FIG. 7, the cart 204 is in a harvesting zone 720. If it is determined that the plant in the cart 204d is ready to harvest, a lifter rotates to push up the upper plate 620 of the cart 204 such that the payload in the cart 204 is removed from the cart 204. Then, the cart 204 continues to follow the primary track 202. If it is determined that the plant in the cart 204 is not ready to harvest, the cart 204 continues to carry the payload and follows the secondary track 710 to provide additional simulated growth time for the plant, similar to the cart 204e. It should be understood that while this might occur at harvesting, this is one embodiment. Some embodiments may include secondary track 710 at a plurality of different levels connecting pillars such that a cart may take any of a plurality of different paths.

In embodiments, the master controller 106 may instruct carts 204 that bypass harvesting at the harvesting zone 720 onto the secondary track 710 based on the remaining growth time for plants in the carts. For example, if the cart 204 bypasses the harvesting process at the harvesting zone 720 (or other area), and the remaining growth time for the plants in the cart 204 is less than a full cycle on the assembly line grow pod 102, the cart 204 may be instructed to take a path on the secondary track 710, which will reduce the overall distance traveled in the next cycle. The cart 204 may move along the sections secondary track 710 and primary track 202 and return to the harvesting zone 720 in less time than a full cycle. In some embodiments, the cart 204 may include a gear system which selects between the primary track 202 and the secondary track 710 to engage. For example, the master controller 106 may send an instruction for bypassing harvesting to the cart 204, and the gear system of the cart 204 may engage with and follow the secondary track 710 in response to receiving the instruction.

lighting devices 304, watering components, and any other devices for growing plants may be installed proximate to sections of the secondary track 710 for growing plants on the secondary track 710, similar to lighting devices 304, watering components, and any other devices for the primary track 202. The master controller 106 may control the lighting devices 304, watering components, and any other devices for growing plants based on the recipe for the plants and/or the growth status of the plants.

In some embodiments, the master controller 106 may control the speed of the carts 204 on the secondary track 710 based on the remaining growth time for the plants in the carts 104b. For example, if the desired time of growth for the plant in the cart 204 is one day, and it takes two days for the cart 204 to go through the secondary track 710 and arrive the harvesting zone 720 at a current speed, then the master controller 106 may increase the speed of the cart 204. As another example, if the required time of growth for the plant in the cart 204 is four days, and it takes two days for the cart 204 to go through the secondary track 710 and arrive the harvesting zone 720 at a current speed, then the master controller 106 may reduce the speed of the cart 204d accordingly. Operations of the lighting devices 304, watering components, and any other devices may be adjusted based on the adjusted speed of the carts 104b.

FIG. 8 depicts a sustenance component 800 for providing water and/or nutrients to a plant in an assembly line grow pod 102, according to embodiments described herein. The sustenance component 800 includes an arrangement of one or more peristaltic pumps 816 relative to the one or more trays 420 held by a cart 204 and supported on the track 202 when the cart 204 is positioned adjacent to the one or more peristaltic pumps 816 within the sustenance component 800. More specifically, FIG. 8 schematically depicts a side view of an illustrative plurality of peristaltic pumps 816 supported on an arm 802 of a robot device 810 (which, collectively, may be referred to as a robot arm) and aligned with a plurality of cells 532 in the tray 420 on the cart 204 supported on the track 202 within the assembly line grow pod 102. That is, each of the plurality of peristaltic pumps 816 may be arranged above a corresponding one of the plurality of cells 532 in the +y direction of the coordinate axes of FIG. 8. However, it should be understood that the plurality of peristaltic pumps 816 may also be arranged above a tray 420 having a single section or space for holding seeds, as described hereinabove.

The plurality of peristaltic pumps 816 supported by the arm 802 of the robot device 810 depicted in FIG. 8 function within the sustenance component 800 as a portion of the water distribution component to supply fluid (e.g., water, nutrients, etc.) to the cells 532 within the tray 420 supported by the cart 204 on the track 202. The sustenance component 800 including the arm 802 of the robot device 810 supporting the plurality of peristaltic pumps 816 may generally be located at any location within the assembly line grow pod 102, but may be particularly located adjacent to the track 202, depending on the embodiment.

In some embodiments, the robot device 810 may further include a base 812 that supports the arm 802 of the robot device 810 (such as a first arm section 802a and a second arm section 802b). The base 812 may be fixed in a particular location or position relative to the track 202. That is in some embodiments, the base 812 of the robot device 810 may not move relative to the track 202. Rather, the cart 204 may move each tray 420 along the track 202 within the vicinity of the arm 802 of the robot device 810 and the peristaltic pumps 816 positioned thereon.

In other embodiments, the base 812 of the robot device 810, the first arm section 802a, and/or the second arm section 802b may each be movable such that the location or positioning of the peristaltic pumps 816 can be changed relative to the tray 420 so as to distribute a precise amount of fluid to each cell 532 (and/or cell 546 from FIG. 5B, depending on the embodiment) within the tray 420. That is, the base 812 of the robot device 810 may be movable (e.g., via wheels, skis, a continuous track, gears, and/or the like), such that the base 812 can traverse an entire length of a tray 420, traverse a portion of the track 202, and/or the like.

Referring again to FIG. 8, the first arm section 802a may be hingedly coupled to the base 812 such that the first arm section 802a is rotatable about the base 812 to change the positioning of the arm 802 (and thus the peristaltic pumps 816) relative to the tray 420. In addition, the second arm section 802b may be hingedly coupled to the first arm section 802a such that the second arm section 802b is rotatable about the first arm section 802a to change the positioning of the arm 802 (and thus the peristaltic pumps 816) relative to the tray 420. The arm sections 802a, 802b may be moved, for example, by actuators or the like (not depicted) that are coupled to each arm section 802a, 802b. While only two arm sections of the arm 802 are depicted in FIG. 8, fewer or greater arm sections are contemplated and included within the scope of the present disclosure.

As a result of the movability of the base 812, the first arm section 802a, and the second arm section 802b, the positioning of the robot device 810 can be adjusted in any manner relative to the tray 420 for the purposes of aligning a particular peristaltic pump 816 with a particular cell 532 of the tray 420. Accordingly, any predetermined amount of fluid can be delivered to any particular cell 532 of the tray 420 at any time, regardless of the size or location of the cell 532 on the tray 420, the movement (or lack thereof) of the tray 420, and/or the like. As a result, the flexible configuration of the sustenance component 800 ensures an appropriate amount of fluid is delivered as needed to ensure optimal growth of the plant material.

Each of the peristaltic pumps 816 may generally include an inlet 818 fluidly coupled to an outlet 820 via a flexible connector tube 822. The inlet 818 is fluidly coupled to a supply tube, which, in turn, is fluidly coupled to a water supply, such as the watering component 109 via the water lines 110 (FIG. 1A) as described herein.

Still referring to FIG. 8, as a result of the configuration of the peristaltic pump 816, the fluid that is received at the inlet 818 from the one or more fluid lines 210 (FIG. 2) via the supply tube may subsequently be distributed out of the peristaltic pump 816 through the outlet 820. In addition, the outlet 820 of each peristaltic pump 816 may be positionable over the tray 420 such that fluid ejected from the outlet 820 is distributed into the tray 420 and/or a cell 532 thereof.

A rotor 824 having a plurality of rollers coupled thereto and spaced apart rotates about an axis, which causes each of the rollers to compress a portion of the flexible connector tube 822. As the rotor 824 turns, the portion of the flexible connector tube 822 under compression is pinched closed (e.g., occludes), thus forcing the fluid to be pumped to move through the connector tube 822 from the inlet 818 towards the outlet 820 between the rollers. Further details regarding the components and functionality of the peristaltic pump should generally be understood, and are not described in greater detail herein. The spacing of the rollers on the rotor 824, the pressure of the fluid (as provided by the various other pumps and valves described herein), and/or the rotational speed may be adjusted to control the amount of fluid that is trapped between the rollers within the flexible connector tube 822 and subsequently ejected out of the outlet 820 into a corresponding one of the cells 532 of the tray 420. For example, a closer spacing of the rollers may result in less spacing between the occluded areas of the connector tube 822, which can hold a smaller volume of fluid, relative to a further apart spacing of the rollers. In another example, an increased fluid pressure supplied to the inlet 818 from the supply tube may force more fluid into the flexible connector tube 822 at a time, relative to a lower fluid pressure supplied to the inlet 818.

In addition to providing a specific amount of fluid to the tray 420 and/or a particular cell 532 of the tray 420, the peristaltic pumps 816 utilize a closed system that reduces or eliminates exposure of the fluid within the components of the peristaltic pumps 816 to contaminants, particulate matter, and/or the like. That is, unlike other components that may be used to distribute fluid to the tray 420, the peristaltic pumps 816 do not directly expose the fluid to moving parts, which may cause contaminants to mix with the fluid. For example, other components that utilize components that involve metal-to-metal contact may generate metallic dust as a result of the metal-to-metal contact, which can mix with the fluids and negatively affect growth of the plant material.

It should be understood that while FIG. 8 depicts eight peristaltic pumps 816 (and eight corresponding outlets 820), the present disclosure is not limited to such. That is, the robot device 810 may support fewer than or greater than eight peristaltic pumps 816 (and eight corresponding outlets 820). In some embodiments, the number of peristaltic pumps 816 (and corresponding outlets 820) may correspond to a number of cells 532 in a particular tray 420 such that a single outlet 820 deposits a precise amount of fluid into a corresponding cell 532. In some embodiments, the number of peristaltic pumps 816 and outlets 820 may correspond to the number of cells 532 that exists across a length of the tray 420. For example, if the tray 420 contains eight cells 532 across the length thereof (as shown in FIG. 8), the arm 802 of the robot device 810 may correspondingly support eight peristaltic pumps 816 (and correspondingly eight outlets 820). In addition, the tray 420 may contain successive rows of cells 532, as shown in FIG. 3. Accordingly, as the cart 204 moves the tray 420 along the track 202 (or as the robot device 810 moves relative to the tray 420), the peristaltic pumps 816 may successively deposit a specific amount of fluid in each successive row as the rows pass under the outlets 820 of the peristaltic pumps 816. It should be understood that due to the movability of the robot device 810 as described herein, a corresponding number of outlets 820 and cells 532 within the tray 420 is not necessary.

The positioning of the various peristaltic pumps 816 with respect to one another is not limited by this disclosure, and may be positioned in any configuration. In some embodiments, the peristaltic pumps 816 may be positioned in a substantially straight line. In other embodiments, the peristaltic pumps 816 may be positioned such that they are staggered in a particular pattern. In yet other embodiments, the peristaltic pumps 816 may be arranged in a grid pattern. In yet other embodiments, the peristaltic pumps 816 may be arranged in a honeycomb pattern and/or movable to fit the desired tray 420.

Some embodiments may also include a sensor that senses various characteristics of the tray 420 and the contents therein. For example, the sensor may include a camera, infrared sensor, laser sensor, pressure sensor, etc. and may be arranged to sense a size, shape, and location of each cell 532 within the tray 420, the location of the interior walls that form the cells 532, a presence, type, and/or amount of growth of plant material within the tray 420, and/or the like. For example, the sensor may be configured as a pressure sensor positioned underneath the tray 420 and/or the cart 204 that detects a weight of a portion of the tray 420 and/or the cart 204. While the embodiment shown in FIG. 8 merely depicts a single sensor, this is also illustrative. In some embodiments, a plurality of sensors may be included. The sensor may be communicatively coupled to various other components of the assembly line grow pod 102 such that signals, data, and/or the like can be transmitted between the sensor 830 and/or the other components, as described in greater detail herein.

FIG. 9 depicts a communication network for operating an assembly line grow pod 102, according to embodiments described herein. As illustrated, the assembly line grow pod 102 may include a master controller 106 (FIG. 1), which may include a pod computing device 930. The pod computing device 930 may include a memory component 940, which stores systems logic 944a and plant logic 944b. As described in more detail below, the systems logic 944a may monitor and control operations of one or more of the components of the assembly line grow pod 102. The plant logic 944b may be configured to determine and/or receive a recipe for plant growth and may facilitate implementation of the grow recipe and/or alteration of the grow recipe via the systems logic 944a.

Additionally, the assembly line grow pod 102 is coupled to a network 950. The network 950 may include the internet or other wide area network, a local network, such as a local area network, a near field network, such as Bluetooth or a near field communication (NFC) network. The network 950 is also coupled to a user computing device 952 and/or a remote computing device 954. The user computing device 952 may include a personal computer, laptop, mobile device, tablet, server, etc. and may be utilized as an interface with a user. As an example, a user may send a recipe to the pod computing device 930 for implementation by the assembly line grow pod 102. Another example may include the assembly line grow pod 102 sending notifications to a user of the user computing device 952.

Similarly, the remote computing device 954 may include a server, personal computer, tablet, mobile device, other assembly line grow pod, other pod computing device, etc. and may be utilized for machine to machine communications. As an example, if the pod computing device 930 determines a type of seed being used (and/or other information, such as ambient conditions), the pod computing device 930 may communicate with the remote computing device 854 to retrieve a previously stored recipe for those conditions. As such, some embodiments may utilize an application program interface (API) to facilitate this or other computer-to-computer communications.

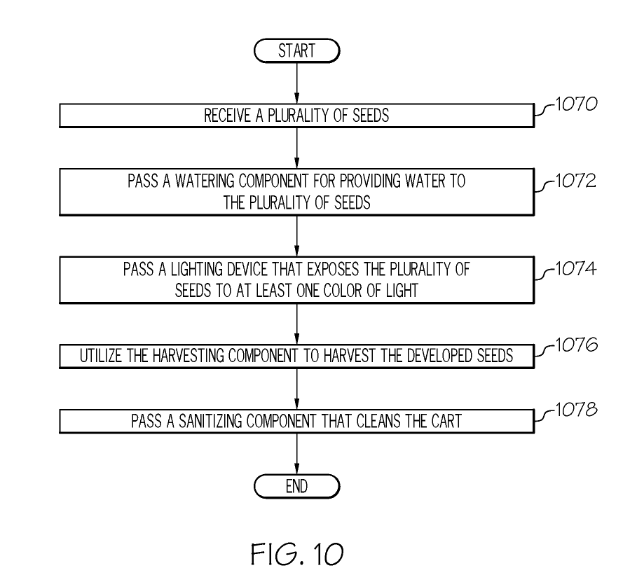

FIG. 10 depicts a flowchart for harvesting a crop from an assembly line grow pod 102, according to embodiments described herein. As illustrated in block 1070, a powered cart 204 traversing a rail receives a plurality of seeds for growth from a seeding component. In block 1072, the cart 204 passes a watering component that exposes the plurality of seeds to water and/or other sustenance. In block 1074, the cart 204 passes a lighting device 304 that exposes the plurality of seeds to at least one color or photon of light, where the at least one color of light facilitates development of the seeds. In block 1076, in response to determining that the seeds have developed for harvesting, the cart 204 passes a harvesting component that automatically harvests the developed seeds. In block 1078, the cart 204 passes a sanitizer component 308 for cleaning the cart 204.

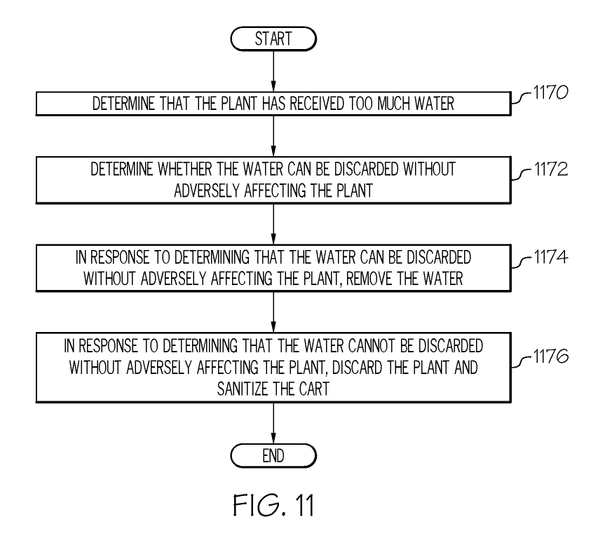

FIG. 11 depicts a flowchart for determining whether plants in an assembly line grow pod 102 have received an excessive amount of water, according to embodiments described herein. As illustrated in block 1170, a determination may be made that a plant has received too much water. As described above, this determination may be made by a weight sensor, a laser sensor, a camera, an infrared sensor, a moisture sensor, and/or other sensor. In some embodiments, the sensor may detect an amount of unabsorbed water in a tray 420, while some embodiments may instead sense overwatering conditions for the plant, such as root rot. Regardless, in block 1172, a determination may be made regarding whether the water can be discarded without adversely affecting the plant. This determination may include determining the stage of development of the plant, determining an amount of fluid to discard, determining options for discarding the fluid provided by the assembly line grow pod 102, etc. As an example, if the tray includes a spigot 544, such as depicted in FIG. 5B, this may be considered. If not, the master controller 106 may determine that the only mechanism for discarding the water is to overturn the tray. If this will damage and/or discard the plants, the master controller 106 may determine that this is not an option. However, if the determined action will not negatively affect the plants, the water may be removed accordingly. In block 1176, in response to determining that the fluid cannot be discarded without adversely affecting the plant, the plant and fluid may both be discarded and the cart 204 may be sanitized.

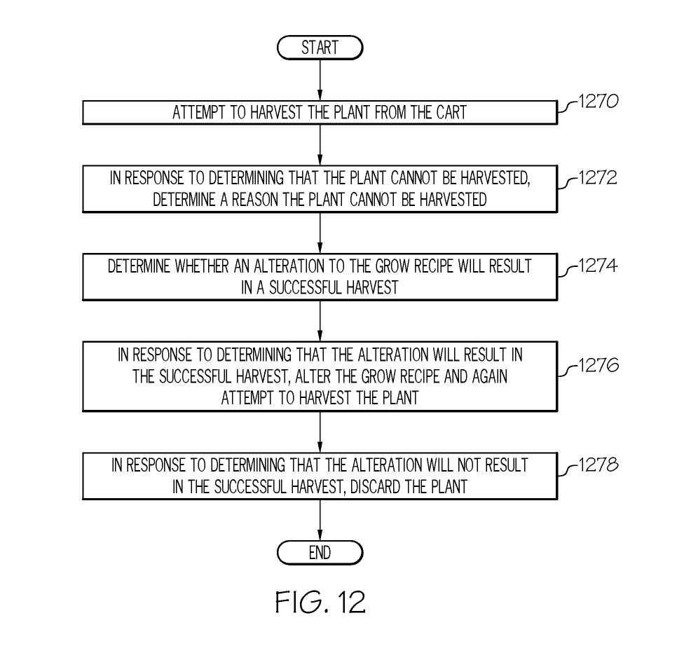

FIG. 12 depicts a flowchart for determining whether a plant can be harvested in an assembly line grow pod 102, according to embodiments described herein. As illustrated in block 1270, an attempt may be made to harvest a plant from a cart 204. Depending on the embodiment, this attempt to harvest may include determining a developmental stage of a plant and/or making a physical attempt to harvest. In block 1272, in response to determining that the plant cannot be harvested, a reason that the plant cannot be harvested may be determined. As an example, it may be determined that the plant is not ready for harvest; that the plant is infested or otherwise damaged; and/or other reasons. In block 1274 a determination may be made regarding whether an alteration to the grow recipe (such as altering actuation of at least one of a plurality of environmental affecters) will result in a successful harvest. If the plant is not ready for harvest, the determination may be made whether the plant can take another turn on the assembly line grow pod 102 (such as via the secondary track 710 from FIG. 7). In block 1276, in response to determining that the alteration will result in a successful harvest, the grow recipe may be altered. After the plant has proceeded again through the grow recipe, the harvest may be again attempted. In block 1278, in response to determining that the alteration to the grow recipe will likely not provide for a successful harvest, the plant may be discarded.

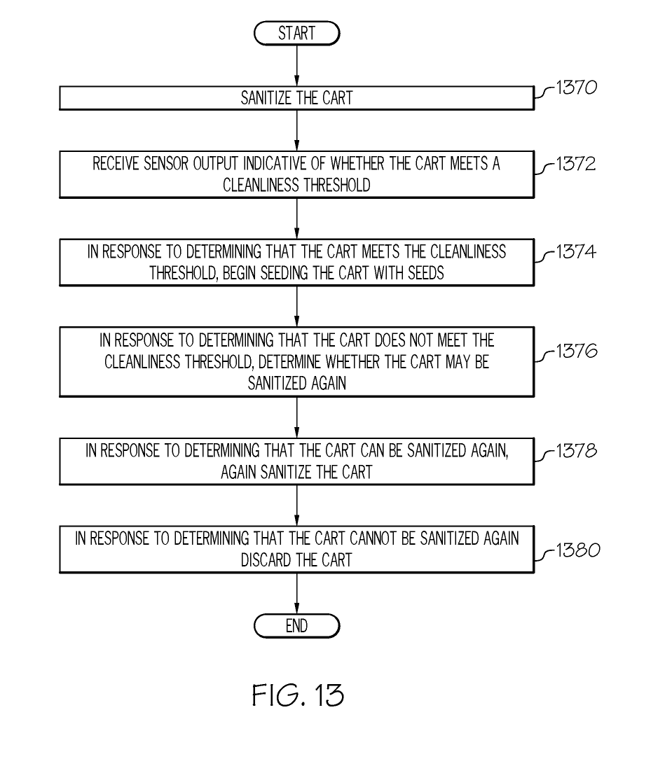

FIG. 13 depicts a flowchart for determining whether a cart 204 in an assembly line grow pod 102 has been sanitized, according to embodiments described herein. As illustrated in block 1370, a cart 204 may be sanitized. In block 1372, a sensor output may be received that is indicative of whether the cart 204 meets a cleanliness threshold. The sensor output may be received from a sensor, such as a camera, lighting sensor, a laser sensor, and/or other sensor that can detect particulate, microbes, and/or other contaminants on the cart 204. In block 1374, in response to determining that the cart 204 meets the cleanliness threshold, seeding of the cart 204 may begin. In block 1376, in response to determining that the cart 204 does not meet the cleanliness threshold, a determination may be made regarding whether the cart 204 may be sanitized again. As an example, the master controller 106 may determine whether the cart 204 is salvageable (e.g., whether cleaning again will result in a positive cleanliness test or whether the cart 204 will not likely help). In block 1378, in response to determining that the cart 204 can be sanitized again, the cart 204 may be sanitized again. In block 1380, in response to determining that the cart 204 cannot be sanitized, the cart 204 may be discarded. In some embodiments, the master controller 106 may then place a new cart 204 into service and/or order a new cart 204 from a retailer.

It should be understood that, as described above, if the cart 204 is to be sanitized again, the cart 204 may take advantage of one or more of the secondary tracks 710. This will allow the cart 204 to return to the sanitizer component 308 (FIG. 3A) more quickly. Similarly, some embodiments may perform this determination in the sanitizer component 308 such that recirculating the cart 204 is unnecessary.

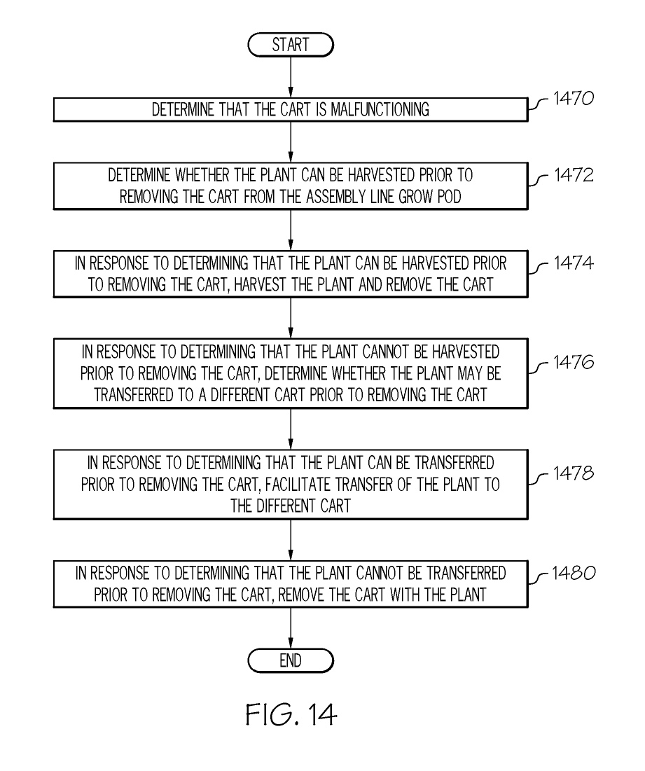

FIG. 14 depicts a flowchart for determining whether a cart 204 in an assembly line grow pod 102 is malfunctioning, according to embodiments described herein. As illustrated in block 1470, a determination may be made that a cart 204 is malfunctioning. This determination may be made via a sensor output from a sensor of the assembly line grow pod 102 itself, or may be provided by the respective cart 204 to the master controller 106. Regardless, in block 1472, a determination may be made regarding whether the plant can be harvested prior to removing the cart 204 from the assembly line grow pod 102. This determination may include determining a nature of the malfunction, predicting a time until total malfunction, determining an effect on other carts in the assembly line grow pod 102, determining a current stage of development of the plant, determining a stage of development of the plant at the time of harvest, etc. In block 1474, in response to determining that the plant can be harvested prior to removing the cart 204, the plant may be harvested and the cart 204 may be removed.

In block 1476, in response to determining that the plant cannot be harvested prior to removing the cart 204, a determination may be made regarding whether the plant may be transferred to a different cart 204 prior to removing the cart 204. As an example, this determination may include determining whether the plant can be safely removed from the current cart 204 and inserted in the new cart 204 without significant damage. This may include a determination of stage of development, a location of roots, etc. In some embodiments, this determination may include determining whether the malfunctioning cart 204 can operate until at a place where transfer can be made. In block 1478, in response to determining that the plant can be transferred prior to removing the cart 204, transfer of the plant to another cart 204 may be facilitated by the master controller 106. As an example, some embodiments of the assembly line grow pod 102 may include a hardware mechanism for removing and inserting plants. However, some embodiments may merely direct the cart 204 to an area for a human to make the transfer. In block 1480, in response to determining that the plant cannot be transferred prior to removing the cart 204, the carts 204 may be removed from operation with the plant.

It should be understood that some embodiments may include a different assembly line grow pod 102 with a different computing device. These embodiments be configured to receive data related to a malfunction of the assembly line grow pod 102 and determine whether a different assembly line grow pod 102 has experienced the malfunction. In response to determining that the different assembly line grow pod 102 has experienced the malfunction, determine a solution for the different assembly line grow pod 102. The data related to the solution may be sent to the assembly line grow pod 102.

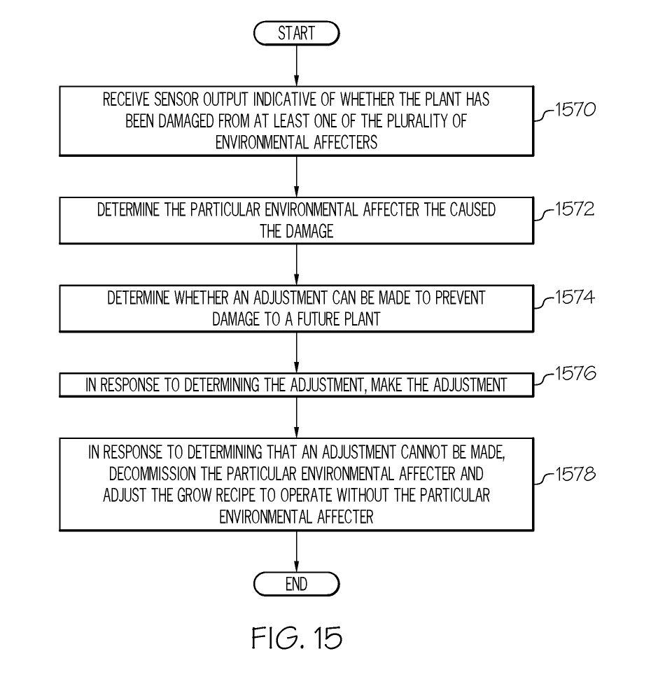

FIG. 15 depicts a flowchart for determining whether a plant has been damaged in an assembly line grow pod 102, according to embodiments described herein. As illustrated in block 1570, sensor output may be received that is indicative of whether a plant has been damaged by an environmental affecter of the assembly line grow pod 102. The sensor may include a temperature sensor, a camera, an infrared sensor, etc. which may determine a color, shape, temperature, and/or other features of a plant to determine damage. In block 1572, a determination may be made regarding the particular environmental affecter that caused the damage. Specifically, the sensor data may be utilized to determine a time that the damage occurred, determine a type of damage, a location of damage, etc. for determining the environmental affecter that caused the damage. In block 1574, a determination may be made regarding whether an adjustment can be made to the environmental affecter (or other component of the assembly line grow pod 102) to prevent damage to a future plant. As an example, if the damage was caused by a heating element of a HVAC system, it may be determined that the location of the heating element is improper and moving the heating element will likely prevent future damage. In block 1576, in response to determining the adjustment, make the adjustment. In block 1578, in response to determining that an adjustment cannot be made, the particular environmental affecter may be decommissioned and the grow recipe may be adjusted to operate without the particular environmental affecter.

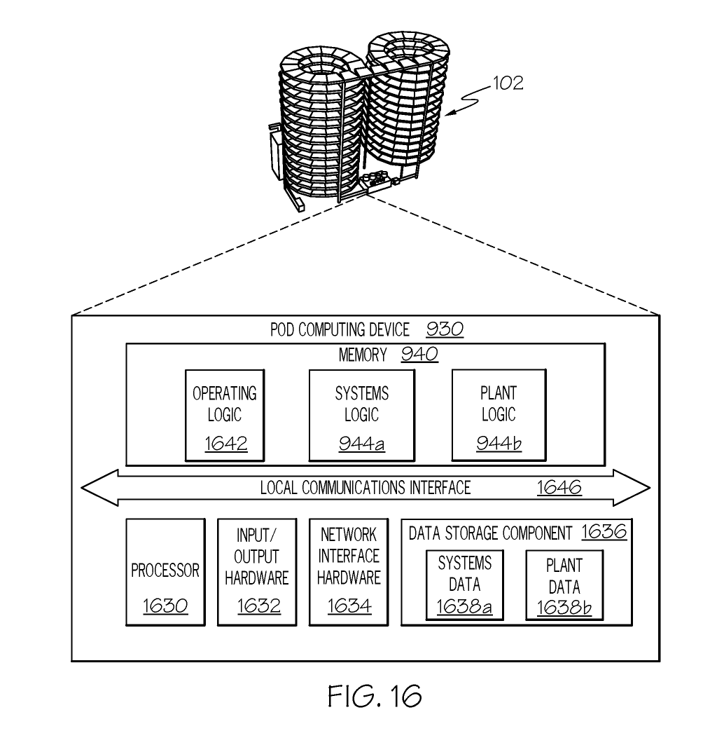

FIG. 16 depicts a pod computing device 930 for an assembly line grow pod 102, according to embodiments described herein. As illustrated, the pod computing device 930 includes a processor 1630, input/output hardware 1632, the network interface hardware 1634, a data storage component 1636 (which stores systems data 1638a, plant data 1638b, and/or other data), and the memory component 940. The memory component 940 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the pod computing device 930 and/or external to the pod computing device 930.

The memory component 940 may store operating logic 1642, the systems logic 944a, and the plant logic 944b. The systems logic 944a and the plant logic 944b may each include a plurality of different pieces of logic, each of which may be embodied as a computer program, firmware, and/or hardware, as an example. A local interface 1646 is also included in FIG. 16 and may be implemented as a bus or other communication interface to facilitate communication among the components of the pod computing device 930.

The processor 1630 may include any processing component operable to receive and execute instructions (such as from a data storage component 1636 and/or the memory component 940). The input/output hardware 1632 may include and/or be configured to interface with microphones, speakers, a display, and/or other hardware.

The network interface hardware 1634 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the pod computing device 930 and other computing devices, such as the user computing device 952 and/or remote computing device 954.

The operating logic 1642 may include an operating system and/or other software for managing components of the pod computing device 930. As also discussed above, systems logic 944a and the plant logic 944b may reside in the memory component 940 and may be configured to perform the functionality, as described herein.

It should be understood that while the components in FIG. 16 are illustrated as residing within the pod computing device 930, this is merely an example. In some embodiments, one or more of the components may reside external to the pod computing device 930. It should also be understood that, while the pod computing device 930 is illustrated as a single device, this is also merely an example. In some embodiments, the systems logic 944a and the plant logic 944b may reside on different computing devices. As an example, one or more of the functionalities and/or components described herein may be provided by the user computing device 952 and/or remote computing device 954.

Additionally, while the pod computing device 930 is illustrated with the systems logic 944a and the plant logic 944b as separate logical components, this is also an example. In some embodiments, a single piece of logic (and/or or several linked modules) may cause the pod computing device 930 to provide the described functionality.

As illustrated above, various embodiments for providing an assembly line grow pod 102 are disclosed. These embodiments create a quick growing, small footprint, chemical free, low labor solution to growing microgreens and other plants for harvesting. These embodiments may create recipes and/or receive recipes that dictate the timing and wavelength of light, pressure, temperature, watering, nutrients, molecular atmosphere, and/or other variables the optimize plant growth and output. The recipe may be implemented strictly and/or modified based on results of a particular plant, tray, or crop.

Accordingly, some embodiments may include an assembly line grow pod 102 that includes a rail system that wraps around a first axis on an ascending portion and a second axis on a descending side; a cart with a tray for receiving seeds; a seeder component for automatically seeding the tray; a lighting device for providing light to the seeds, wherein the lighting device operates according to a recipe; a harvesting component for harvesting developed plants from the tray; and a rail that transports the cart 204 from the seeding component to the harvesting component and back to the seeding component.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for providing an assembly line grow pod 102. It should also be understood that these embodiments are merely exemplary and are not intended to limit the scope of this disclosure.

1. An assembly line grow pod comprising:
an exterior enclosure that defines an environmentally enclosed volume;
a track that is shaped into a plurality of helical structures defining a path;
a cart that receives a plant and traverses the track;
a sensor for determining output of the plant;
a plurality of environmental affecters that alter an environment of the environmentally enclosed volume to alter the output of the plant; and
a pod computing device that stores a grow recipe that, when executed by a processor of the pod computing device, actuates at least one of the plurality of environmental affecters,
wherein the grow recipe alters a planned actuation of the at least one of the plurality of environmental affecters in response to data from the sensor indicating a current output of the plant.

2. The assembly line grow pod of claim 1, further comprising a seeder component, wherein the seeder component includes a reservoir of seeds and a seed dispensing component that dispenses individual seeds into a predetermined cell of the cart.

3. The assembly line grow pod of claim 1, further comprising a watering component for watering the plant at predetermined times according to the grow recipe, wherein the watering component is implemented via a robot arm that deposits a predetermined amount of water into a cell in which the plant resides.

4. The assembly line grow pod of claim 1, wherein the logic further causes the assembly line grow pod to perform at least the following:
determine that the plant has received excess water;
determine whether the excess water can be discarded without adversely affecting the plant;
in response to determining that at least the excess water can be discarded without adversely affecting the plant, remove the excess water; and
in response to determining that the excess water cannot be discarded without adversely affecting the plant, discard the plant and sanitize the cart.

5. The assembly line grow pod of claim 1, further comprising a nutrient dosing component for providing nutrients to the plant at predetermined times according to the grow recipe, wherein the nutrient dosing component is implemented via a robot arm that deposits a predetermined amount of nutrients into a cell in which the plant resides.

6. The assembly line grow pod of claim 1, further comprising a harvesting component for harvesting the plant.

7. The assembly line grow pod of claim 6, wherein the logic further causes the assembly line grow pod to perform at least the following:
attempt to harvest the plant from the cart;
in response to determining that the plant cannot be harvested, determine a reason the plant cannot be harvested;
determine whether an alteration to the grow recipe will result in a successful harvest;
in response to determining that the alteration will result in the successful harvest, alter the grow recipe and again attempt to harvest the plant; and
in response to determining that the alteration will not result in the successful harvest, discard the plant.

8. The assembly line grow pod of claim 1, further comprising a sanitizer component that receives the cart that has had the plant harvested, wherein the sanitizer component deposits a solution on the cart for sanitizing the cart for a next use.

9. The assembly line grow pod of claim 8, wherein the logic further causes the assembly line grow pod to perform at least the following:
sanitize the cart;
receive output from a different sensor indicative of whether the cart meets a cleanliness threshold;
in response to determining that the cart meets the cleanliness threshold, begin seeding the cart with seeds;
in response to determining that the cart does not meet the cleanliness threshold, determine whether the cart may be sanitized again;
in response to determining that the cart can be sanitized again, again sanitize the cart; and
in response to determining that the cart cannot be sanitized again, discarding the cart.

10. The assembly line grow pod of claim 1, wherein:
the cart includes a tray for receiving the plant as a seed; and
the tray rotates at least about 90 degrees to harvest the plant.

11. The assembly line grow pod of claim 1, wherein the logic further causes the assembly line grow pod to perform at least the following:
determine that the cart is malfunctioning;
determine whether the plant can be harvested prior to removing the cart from the assembly line grow pod; and
in response to determining that the plant can be harvested prior to removing the cart, harvest the plant and remove the cart.

12. The assembly line grow pod of claim 11, wherein the logic further causes the assembly line grow pod to perform at least the following:
in response to determining that the plant cannot be harvested prior to removing the cart, determine whether the plant may be transferred to a different cart prior to removing the cart;
in response to determining that the plant can be transferred prior to removing the cart, facilitate transfer of the plant to the different cart; and
in response to determining that the plant cannot be transferred prior to removing the cart, remove the cart with the plant.

13. The assembly line grow pod of claim 1, wherein the logic further causes the assembly line grow pod to perform at least the following:
receive output from a different sensor indicative of whether the plant has been damaged from at least one of the plurality of environmental affecters;
determine a particular environmental affecter that caused damage to the plant;
determine whether an adjustment can be made to prevent damage to a future plant;
in response to determining the adjustment, make the adjustment; and
in response to determining that an adjustment cannot be made, decommission the particular environmental affecter and adjust the grow recipe to operate without the particular environmental affecter.

14. A system comprising:
an assembly line grow pod that includes:
an exterior enclosure that defines an environmentally enclosed volume;
a track that is shaped into a plurality of helical structures defining a path;
a cart that includes a tray that receives a payload in the tray and traverses the track;
a sensor for determining output of the payload;
an environmental affecter that alters an environment of the environmentally enclosed volume to alter the output of the payload; and
a pod computing device that stores a grow recipe that, when executed by a processor of the pod computing device, actuates the environmental affecter,
wherein the grow recipe alters a planned actuation of the environmental affecter in response to data from the sensor indicating a current output of the payload.

15. The system of claim 14, further comprising a remote computing device that performs at least the following:
receive data related to a malfunction of the assembly line grow pod;
determine whether a different assembly line grow pod has experienced the malfunction;
in response to determining that the different assembly line grow pod has experienced the malfunction, determine a solution for the different assembly line grow pod; and
send data related to the solution to the assembly line grow pod.

16. The system of claim 14, further comprising a different assembly line grow pod that includes a different computing device that performs at least the following:
receive data related to a malfunction of the assembly line grow pod;
determine whether the different assembly line grow pod has experienced the malfunction;
in response to determining that the different assembly line grow pod has experienced the malfunction, determine a solution for the different assembly line grow pod; and
send data related to the solution to the assembly line grow pod.

17. An assembly line grow pod comprising:
an exterior enclosure that defines an environmentally enclosed volume;
a track that is shaped into a plurality of helical structures defining a path;
a plurality of carts that each receives a respective seed for growing into a plant, wherein each of the plurality of carts traverses the track;
a sensor for determining output of the plant;
an environmental affecter that alters an environment of the environmentally enclosed volume to alter the output of the plant; and
a pod computing device that stores a grow recipe that, when executed by a processor of the pod computing device, actuates the environmental affecter,
wherein the grow recipe alters a planned actuation of the environmental affecter in response to data from the sensor indicating a current output of the plant.

18. The assembly line grow pod of claim 17, wherein the logic further causes the assembly line grow pod to perform at least the following:
attempt to harvest the plant from one of the plurality of carts;
in response to determining that the plant cannot be harvested, determine a reason the plant cannot be harvested;
determine whether an alteration to the grow recipe will result in a successful harvest;
in response to determining that the alteration will result in a successful harvest, alter the grow recipe and again attempt to harvest the plant; and
in response to determining that the alteration will not result in the successful harvest, discard the respective cart.

19. The assembly line grow pod of claim 17, wherein the logic further causes the assembly line grow pod to perform at least the following:
determine that one of the plurality of carts is malfunctioning:
determine whether the plant can be harvested prior to removing a cart of the plurality of carts from the assembly line grow pod;
in response to determining that the plant can be harvested prior to removing the cart, harvest the plant and remove the cart;
in response to determining that the plant cannot be harvested prior to removing the cart, determine whether the plant may be transferred to a different cart of the plurality of carts prior to removing the cart;
in response to determining that the plant can be transferred prior to removing the cart, facilitate transfer of the plant to the different cart; and
in response to determining that the plant cannot be transferred prior to removing the cart, remove the cart with the plant.

20. The assembly line grow pod of claim 17, wherein the logic further causes the assembly line grow pod to perform at least the following:
receive output from a different sensor indicative of whether the plant has been damaged by the environmental affecter;
determine a particular environmental affecter that caused damage to the plant;
determine whether an adjustment can be made to prevent damage to a future plant;
in response to determining the adjustment, make the adjustment; and
in response to determining that an adjustment cannot be made, decommission the particular environmental affecter and adjust the grow recipe to operate without the particular environmental affecter.
